(19) United States
(12) Patent Application Publication
(10) Pub. No.: US 2024/0329323 A1
(43) Pub. Date: Oct. 3, 2024

(54) OPTICAL COUPLER, OPTICAL COUPLING MEMBER, VISIBLE LIGHT SOURCE MODULE, AND OPTICAL ENGINE

(71) Applicant: TDK CORPORATION, Tokyo (JP)

(72) Inventors: Atsushi SHIMURA, Tokyo (JP); Yasuhiro TAKAGI, Tokyo (JP); Hiroki HARA, Tokyo (JP); Jiro YOSHINARI, Tokyo (JP)

(73) Assignee: TDK CORPORATION, Tokyo (JP)

(21) Appl. No.: 18/429,669

(22) Filed: Feb. 1, 2024

(30) Foreign Application Priority Data
Mar. 29, 2023 (JP) 2023-053015

(51) Int. Cl. G02B 6/35; G02B 6/27

(52) U.S. Cl. CPC G02B 6/354; G02B 6/272

(57) ABSTRACT

This optical coupler includes a plurality of light input ports to which a plurality of visible light beams can be input, a light output port capable of coupling all of the plurality of visible light beams and outputting coupled light, an optical coupling portion to which a light-input-side optical waveguide and a light-output-side optical waveguide are connected, and at least one high-order mode removal portion provided to remove a high mode with respect to each of the plurality of visible light beams. The optical coupling portion and each high-order mode removal portion are arranged so that each of the plurality of visible light beams passes through only a high-order mode removal portion for visible light or passes through only the high-order mode removal portion for the visible light and a high-order mode removal portion for visible light having a shorter wavelength than the visible light.

### BACKGROUND OF THE INVENTION

### Field of the Invention

The present invention relates to an optical coupler, an optical coupling member, a visible light source module, and an optical engine.

The present application claims priority on Japanese Patent Application No. 2023-053015 filed on Mar. 29, 2023, the content of which is incorporated herein by reference.

### Description of Related Art

At present, spectacle terminals are being studied in XR technologies such as virtual reality (VR) and augmented reality (AR). In particular, in recent years, retinal scanning displays for allowing a user to see an image by forming two-dimensionally scanned light on the user's retina have attracted attention. In the retinal scanning displays, in general, three colors of visible light beams output from light sources such as light emitting diodes (LEDs) and laser diodes (LDs) corresponding to colors of red (R), green (G), and blue (B) are coupled on one optical axis. Light obtained by coupling the visible light beams of the three colors is transmitted to an image display portion. The image display portion two-dimensionally scans the transmitted light and inputs the light to the user's pupil. This input light forms an image on the retina of the user, so that the user can see the image. In this case, the retina is a screen that displays the image.

For example, Patent Document 1 discloses a configuration of a retina-projection-type display using a Mach-Zehnder-type optical modulator.

In the retina-projection-type display disclosed in Patent Document 1, a plurality of optical waveguides are located to be close to each other in an output portion, but an optical axis for each wavelength is different and the control of the output light becomes complicated because the optical waveguides are not coupled.

Also, there is a need for an optical coupler that can be connected or integrated with a visible light modulator and can adjust the RGB color balance, but it has not been studied at all at present.

However, in Patent Document 1, the optical waveguides are only close to each other in the output portion, but are not coupled. Therefore, because the optical axis for each wavelength is different, the control of the output light becomes complicated.

Also, Patent Document 2 discloses a visible light modulator using a lithium niobate film. An RGB optical coupler capable of being connected or integrated with a visible light modulator using a lithium niobate film is required, but at present no consideration has been given thereto.

For visible light coupling, directional couplers are generally considered (see, for example, Patent Document 3). These are made of glass-based materials and have excellent stability, but when a lithium niobate substrate having a large value of Δn is used, a coupling length becomes long and miniaturization cannot be performed.

Although configurations of RGB couplers using a multimode interferometer (MMI) are disclosed in Patent Document 4 and Patent Document 5, both configurations are made of glass-based materials and no configuration using a lithium niobate film is disclosed.

It is desirable to output RGB light output from the optical coupler in a single mode. Also, it is desirable because single-mode light does not cause mode dispersion during light propagation and hence the light propagation loss is smaller and the propagation speed is faster than that of multimode light. However, there is no specific proposal for a small optical coupler that can be mounted on a glasses-type terminal or the like as an optical coupler capable of outputting light in the single mode through multimode removal.

### PATENT DOCUMENTS

[Patent Document 1] Japanese Patent No. 6728596
[Patent Document 2] Japanese Patent No. 6787397
[Patent Document 3] Japanese Patent No. 6572377
[Patent Document 4] Japanese Unexamined Patent Application, First Publication No. 2012-48071
[Patent Document 5] Japanese Unexamined Patent Application, First Publication No. 2020-27170

### SUMMARY OF THE INVENTION

The present invention has been made in view of the above-described problems and an objective of the present invention is to provide an optical coupler, an optical coupling member, a visible light source module, and an optical engine capable of making a connection or integration with an optical modulator using a lithium niobate film and outputting light in a single mode through multimode removal.

To solve the above-described problems, the present invention provides the following features.

According to aspect 1 of the present invention, there is provided an optical coupler for coupling a plurality of visible light beams having different wavelengths, the optical coupler including: a plurality of light input ports to which the plurality of visible light beams can be input; a light output port capable of coupling all of the plurality of visible light beams and outputting coupled light; a one- or more-stage optical coupling portion to which a light-input-side optical waveguide and a light-output-side optical waveguide are connected; and at least one high-order mode removal portion for visible light provided to remove a high mode with respect to each of the plurality of visible light beams, wherein the optical coupling portion and each high-order mode removal portion for visible light are arranged so that each of the plurality of visible light beams passes through only a high-order mode removal portion for visible light or passes through only the high-order mode removal portion for the visible light and a high-order mode removal portion for visible light having a shorter wavelength than the visible light.

According to aspect 2 of the present invention, in the optical coupler according to aspect 1, the plurality of visible light beams having the different wavelengths are blue light whose peak wavelength is 380 nm to 500 nm, green light whose peak wavelength is 500 nm to 600 nm, and red light whose peak wavelength is 600 nm to 830 nm, the blue light passes through only a high-order mode removal portion for the blue light, the green light passes through only a high-order mode removal portion for the green light or passes through the high-order mode removal portion for the green light and the high-order mode removal portion for the blue light, and the red light passes through only a high-order mode removal portion for the red light, passes through only the high-order mode removal portion for the red light and the high-order mode removal portion for the green light, or passes through the high-order mode removal portion for the red light, the high-order mode removal portion for the green light, and the high-order mode removal portion for the blue light.

According to aspect 3 of the present invention, in the optical coupler according to aspect 1 or 2, the optical coupling portion includes a first multimode-interference-type optical coupling portion having two inputs and one output and a second multimode-interference-type optical coupling portion having two inputs and one output, and an optical waveguide for the red light and an optical waveguide for the green light are connected to a light input side of the first multimode-interference-type optical coupling portion, an optical waveguide connected to a light output side of the first multimode-interference-type optical coupling portion and an optical waveguide for the blue light are connected to a light input side of the second multimode-interference-type optical coupling portion, and an optical waveguide connected to a light output side of the second multimode-interference-type optical coupling portion is connected to the light output port.

According to aspect 4 of the present invention, in the optical coupler according to aspect 3, the high-order mode removal portion for the blue light is arranged in an optical waveguide for connecting the light output side of the second multimode-interference-type optical coupling portion and the light output port.

According to aspect 5 of the present invention, in the optical coupler according to aspect 3, the high-order mode removal portion for the blue light is arranged in an optical waveguide for connecting the light input side of the second multimode-interference-type optical coupling portion and the light input port for the blue light.

According to aspect 6 of the present invention, in the optical coupler according to aspect 1 or 2, the optical coupling portion includes a first multimode-interference-type optical coupling portion having two inputs and one output and a second multimode-interference-type optical coupling portion having two inputs and one output, and an optical waveguide for the red light and an optical waveguide for the blue light are connected to a light input side of the first multimode-interference-type optical coupling portion, an optical waveguide connected to a light output side of the first multimode-interference-type optical coupling portion and an optical waveguide for the green light are connected to a light input side of the second multimode-interference-type optical coupling portion, and an optical waveguide connected to a light output side of the second multimode-interference-type optical coupling portion is connected to the light output port.

According to aspect 7 of the present invention, in the optical coupler according to aspect 6, the high-order mode removal portion for the blue light is arranged in an optical waveguide for connecting the light output side of the second multimode-interference-type optical coupling portion and the light output port.

According to aspect 8 of the present invention, in the optical coupler according to aspect 6, the high-order mode removal portion for the blue light is arranged in an optical waveguide for connecting the light output side of the first multimode-interference-type optical coupling portion and the light input side of the second multimode-interference-type optical coupling portion.

According to aspect 9 of the present invention, in the optical coupler according to aspect 6, the high-order mode removal portion for the blue light is arranged in an optical waveguide for connecting the light input side of the first multimode-interference-type optical coupling portion and the light input port for the blue light.

According to aspect 10 of the present invention, in the optical coupler according to aspect 1 or 2, the optical coupling portion includes a first multimode-interference-type optical coupling portion having two inputs and one output and a second multimode-interference-type optical coupling portion having two inputs and one output, and an optical waveguide for the green light and an optical waveguide for the blue light are connected to a light input side of the first multimode-interference-type optical coupling portion, an optical waveguide connected to a light output side of the first multimode-interference-type optical coupling portion and an optical waveguide for the red light are connected to a light input side of the second multimode-interference-type optical coupling portion, and an optical waveguide connected to a light output side of the second multimode-interference-type optical coupling portion is connected to the light output port.

According to aspect 11 of the present invention, in the optical coupler according to aspect 10, the high-order mode removal portion for the blue light is arranged in an optical waveguide for connecting the light output side of the second multimode-interference-type optical coupling portion and the light output port.

According to aspect 12 of the present invention, in the optical coupler according to aspect 10, the high-order mode removal portion for the blue light is arranged in an optical waveguide for connecting the light output side of the first multimode-interference-type optical coupling portion and the light input side of the second multimode-interference-type optical coupling portion.

According to aspect 13 of the present invention, in the optical coupler according to aspect 10, the high-order mode removal portion for the blue light is arranged in an optical waveguide for connecting the light input side of the first multimode-interference-type optical coupling portion and the light input port for the blue light.

According to aspect 14 of the present invention, in the optical coupler according to aspect 1 or 2, the optical coupling portion includes a multimode-interference-type optical coupling portion having three inputs and one output, and an optical waveguide for the red light, an optical waveguide for the green light, and an optical waveguide for the blue light are connected to a light input side of the multimode-interference-type optical coupling portion having three inputs and one output and an optical waveguide connected to a light output side of the multimode-interference-type optical coupling portion having three inputs and one output is connected to the light output port.

According to aspect 15 of the present invention, in the optical coupler according to aspect 14, the high-order mode removal portion for the blue light is arranged in an optical waveguide for connecting a light output side of the multimode-interference-type optical coupling portion having three inputs and one output and the light output port.

According to aspect 16 of the present invention, in the optical coupler according to any one of aspects 1 to 15, the high-order mode removal portion includes a bending waveguide.

According to aspect 17 of the present invention, in the optical coupler according to aspect 16, a line width of the bending waveguide is 2.0 μm or less.

According to aspect 18 of the present invention, in the optical coupler according to aspect 16 or 17, a line width of the bending waveguide is 0.2 μm or more.

According to aspect 19 of the present invention, in the optical coupler according to any one of aspects 1 to 18, the optical coupler includes a one- or more-stage multimode-interference-type optical coupling portion.

According to aspect 20 of the present invention, there is provided an optical coupling member including: a substrate made of a material different from lithium niobate; and an optical coupling function layer including a lithium niobate film formed on a main surface of the substrate, wherein the optical coupler according to any one of aspects 1 to 19 is formed in the optical coupling function layer.

According to aspect 21 of the present invention, there is provided a visible light source module including: the optical coupling member according to aspect 20; and a plurality of visible laser light sources configured to output visible light coupled by the optical coupling member.

According to aspect 22 of the present invention, there is provided an optical coupling member having an optical modulation function, including: the optical coupling member according to aspect 20; and a Mach-Zehnder-type optical modulator connected to the optical coupling member and configured to guide a plurality of visible light beams output from a plurality of visible laser light sources to the optical coupling member.

According to aspect 23 of the present invention, there is provided a visible light source module including: the optical coupling member having the optical modulation function according to aspect 22; and a plurality of visible laser light sources configured to output visible light coupled by the optical coupling member having the optical modulation function.

According to aspect 24 of the present invention, there is provided an optical engine including: the visible light source module according to aspect 21; and an optical scanning mirror configured to reflect light output from the visible light source module by changing an angle so that an image is displayed.

According to aspect 25 of the present invention, there is provided an optical engine including: the visible light source module according to aspect 23; and an optical scanning mirror configured to reflect light output from the visible light source module by changing an angle so that an image is displayed.

According to the present invention, an optical coupler can make a connection or integration with an optical modulator using a lithium niobate film and output light in a single mode through multimode removal.

### BRIEF DESCRIPTION OF THE DRAWINGS

FIG. 1 is a schematic plan view showing an optical coupler according to an embodiment of the present invention.

FIG. 2A shows an example of a configuration in which only an arrangement of the optical coupler and a high-order mode removal portion shown in FIG. 1 is different.

FIG. 2B shows an example of a configuration in which only the arrangement of the optical coupler and the high-order mode removal portion shown in FIG. 1 is different.

FIG. 2C shows an example of a configuration in which only the arrangement of the optical coupler and the high-order mode removal portion shown in FIG. 1 is different.

FIG. 2D shows an example of a configuration in which only the arrangement of the optical coupler and the high-order mode removal portion shown in FIG. 1 is different.

FIG. 3A shows an example of a configuration in which only the arrangement of the optical coupler and the high-order mode removal portion shown in FIGS. 2A to 2D is different.

FIG. 3B shows an example of a configuration in which only the arrangement of the optical coupler and the high-order mode removal portion shown in FIGS. 2A to 2D is different.

FIG. 3C shows an example of a configuration in which only the arrangement of the optical coupler and the high-order mode removal portion shown in FIGS. 2A to 2D is different.

FIG. 4 is a schematic plan view showing a second arrangement pattern of the optical coupler according to an embodiment of the present invention.

FIG. 5A shows an example of a configuration in which only an arrangement of the optical coupler and a high-order mode removal portion shown in FIG. 4 is different.

FIG. 5B shows an example of a configuration in which only the arrangement of the optical coupler and the high-order mode removal portion shown in FIG. 4 is different.

FIG. 5C shows an example of a configuration in which only the arrangement of the optical coupler and the high-order mode removal portion shown in FIG. 4 is different.

FIG. 6A shows an example of a configuration in which only the arrangement of the optical coupler and the high-order mode removal portion shown in FIGS. 5A to 5C is different.

FIG. 6B shows an example of a configuration in which only the arrangement of the optical coupler and the high-order mode removal portion shown in FIGS. 5A to 5C is different.

FIG. 6C shows an example of a configuration in which only the arrangement of the optical coupler and the high-order mode removal portion shown in FIGS. 5A to 5C is different.

FIG. 7 is a schematic plan view showing a third arrangement pattern of the optical coupler according to the embodiment of the present invention.

FIG. 8A shows an example of a configuration in which only an arrangement of the optical coupler and a high-order mode removal portion shown in FIG. 7 is different.

FIG. 8B shows an example of a configuration in which only the arrangement of the optical coupler and the high-order mode removal portion shown in FIG. 7 is different.

FIG. 8C shows an example of a configuration in which only the arrangement of the optical coupler and the high-order mode removal portion shown in FIG. 7 is different.

FIG. 9A shows an example of a configuration in which only the arrangement of the optical coupler and the high-order mode removal portion shown in FIGS. 8A to 8C is different.

FIG. 9B shows an example of a configuration in which only the arrangement of the optical coupler and the high-order mode removal portion shown in FIGS. 8A to 8C is different.

FIG. 9C shows an example of a configuration in which only the arrangement of the optical coupler and the high-order mode removal portion shown in FIGS. 8A to 8C is different.

FIG. 10 is a schematic plan view showing a one-stage optical coupler according to the embodiment of the present invention.

FIG. 11A shows an example of a configuration in which only the arrangement of the optical coupler and the high-order mode removal portion shown in FIGS. 9A to 9C is different.

FIG. 11B shows an example of a configuration in which only the arrangement of the optical coupler and the high-order mode removal portion shown in FIGS. 9A to 9C is different.

FIG. 12A shows a simulation result for a relationship between a radius of a circumferential shape portion of a bending waveguide and propagation losses of basic mode light and high-order mode light.

FIG. 12B shows a planar shape of a model of the bending waveguide used in the simulation of FIG. 12A.

FIG. 12C shows a simulation result for the relationship between the radius of the circumferential shape portion of the bending waveguide and the propagation losses of the basic mode light and the high-order mode light.

FIG. 12D shows a planar shape of the model of the bending waveguide used in the simulation of FIG. 12C.

FIG. 12E shows a simulation result for the relationship between the radius of the circumferential shape portion of the bending waveguide and the propagation losses of the basic mode light and the high-order mode light.

FIG. 12F shows a planar shape of the model of the bending waveguide used in the simulation of FIG. 12E.

FIG. 13 is a schematic cross-sectional diagram of a simulation model.

FIG. 14A shows a simulation result for a relationship between a width of a bending waveguide for red light and the propagation losses of the basic mode light and the high-order mode light.

FIG. 14B shows a simulation result for a relationship between a width of a bending waveguide for green light and the propagation losses of the basic mode light and the high-order mode light.

FIG. 14C shows a simulation result for a relationship between a width of a bending waveguide for blue light and the propagation losses of the basic mode light and the high-order mode light.

FIG. 15A shows a simulation result for a relationship between a combination of the width of the bending waveguide for red light and the radius of the circumferential shape portion and the propagation losses of the basic mode light and the high-order mode light.

FIG. 15B shows a simulation result for a relationship between a combination of the width of the bending waveguide for the green light and the radius of the circumferential shape portion and the propagation losses of the basic mode light and the high-order mode light.

FIG. 15C shows a simulation result for a relationship between a combination of the width of the bending waveguide for blue light and the radius of the circumferential shape portion and the propagation losses of the basic mode light and the high-order mode light.

FIG. 16 is a schematic cross-sectional view of an optical coupler in which the components shown in FIG. 1 are formed on an optical coupling function layer made of lithium niobate cut along line X-X′ of FIG. 1.

FIG. 17 is a schematic plan view of a modified example of an optical coupling member according to an embodiment of the present invention.

FIG. 18 is a schematic plan view of a visible light source module according to a first embodiment.

FIG. 19 is a schematic plan view of a visible light source module according to a second embodiment.

FIG. 20 is a conceptual diagram for describing an optical engine according to the present embodiment.

### DETAILED DESCRIPTION OF THE INVENTION

Hereinafter, embodiments will be described in detail with reference to the drawings as appropriate. In the drawings used in the following description, featured parts may be enlarged for convenience such that the features of the present invention are easier to understand, and dimensional ratios and the like of the respective components may be different from actual ones. Materials, dimensions, and the like exemplified in the following description are examples, the present invention is not limited thereto, and modifications can be appropriately made in a range in which advantageous effects of the present invention are exhibited.

### [Optical Coupler]

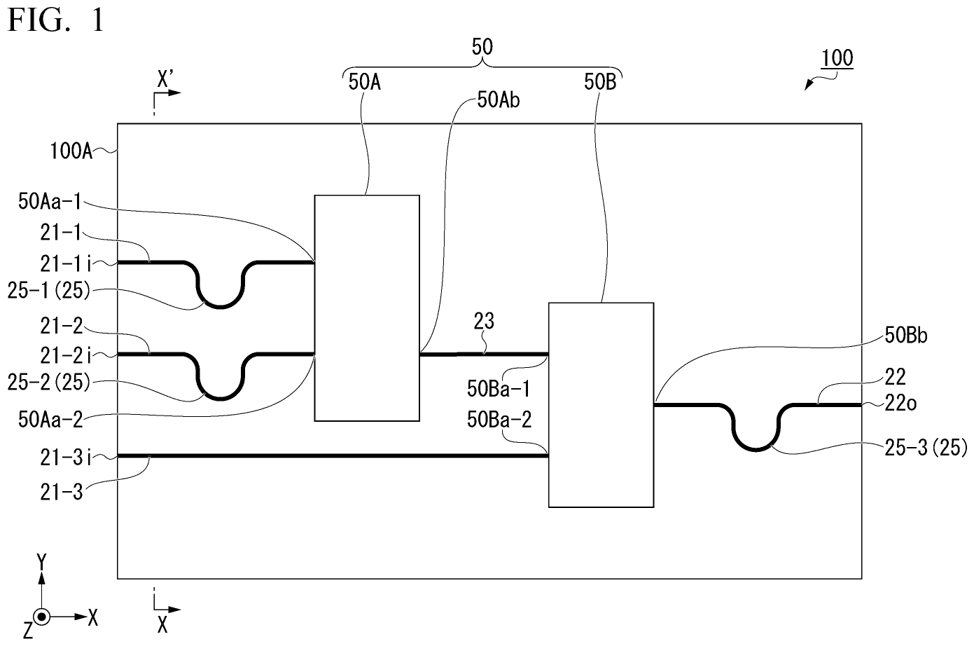

FIG. 1 is a schematic plan view showing an optical coupler according to an embodiment of the present invention.

An optical coupler 100 shown in FIG. 1 is an optical coupler for coupling visible light having three different wavelengths, the optical coupler including: a plurality of light input ports (a first light input port 21-1i, a second light input port 21-2i, and a third light input port 21-3i) to which the visible light beams having the three different wavelengths can be input; a light output port 22o capable of coupling and outputting all of the visible light beams having the three different wavelengths; a two-stage optical coupling portion 50 (50A and 50B) to which a light-input-side optical waveguide and a light-output-side optical waveguide are connected; and at least one high-order mode removal portion 25 (25-1, 25-2, or 25-3) for visible light provided to remove a high mode with respect to each of the visible light beams having the three different wavelengths, wherein the two-stage optical coupling portion 50 and each high-order mode removal portion 25 (25-1, 25-2, or 25-3) for visible light are arranged so that each of the visible light beams having the three different wavelengths passes through only a high-order mode removal portion for visible light or passes through only the high-order mode removal portion for the visible light and a high-order mode removal portion for visible light having a shorter wavelength than the visible light.

In FIG. 1, an X-direction is a direction orthogonal to a side surface 100A on which the light input port is arranged, a Y-direction is a direction orthogonal to the X-direction, and a Z-direction is a direction orthogonal to the surface formed in the X-direction and the Y-direction.

In the optical coupler 100 shown in FIG. 1, the optical coupling portion has a two-stage configuration but may have a configuration of one stage or three or more stages. Although an example in which the optical coupling portion of each stage is an optical coupling portion having two inputs and one output and an optical coupling portion having three inputs and one output will be described below, the number of inputs and the number of outputs are not limited thereto.

The high-order mode removal portion for visible light is a portion configured to pass visible light of only a basic mode without loss among a basic mode (a 0-order mode or a single mode) and high-order modes (a first-order mode, a second-order mode, . . . , (multimode)) of visible light.

As a configuration of the high-order mode removal portion, a bending waveguide can be exemplified. Hereinafter, a case where the high-order mode removal portion is a bending waveguide will be described as an example. Also, as another example of the configuration of the high-order mode removal portion, the high-order mode can be removed by setting a line width of the optical waveguide to a predetermined width.

When the visible light beams having the three different wavelengths are, for example, red light (R), green light (G), and blue light (B), the high-order mode removal portion through which visible light passes is limited as follows.

The blue light having a shortest wavelength passes through only the high-order mode removal portion for the blue light.

On the other hand, in addition to a case where the red light having a longest wavelength passes through only a high-order mode removal portion for the red light, there are a case where the red light passes through the high-order mode removal portion for the red light and either one of a high-order mode removal portion for the green light having a shorter wavelength than the red light or the high-order mode removal portion for the blue light having a shorter wavelength than the red light, and a case where the red light passes through the high-order mode removal portion for the red light and both the high-order mode removal portion for the green light and the high-order mode removal portion for the blue light.

Also, in addition to a case where the green light having an intermediate wavelength length between the red light and the blue light passes through only the high-order mode removal portion for the green light, there is a case where the green light passes through the high-order mode removal portion for the green light and the high-order mode removal portion for the blue light having a shorter wavelength than the green light.

As shown in the following simulations, a loss of a basic mode (TM0) is undesirably caused when visible light having a shorter wavelength passes through a high-order mode removal portion for visible light having a longer wavelength than the visible light. On the other hand, visible light having a longer wavelength can pass through a high-order mode removal portion for visible light having a shorter wavelength than the visible light because no loss of the basic mode (TM0) occurs.

Although the optical coupler 100 shown in FIG. 1 has a configuration in which three input ports (a first light input port 21-1i, a second light input port 21-2i, and a third light input port 21-3i) are provided in correspondence with the visible light beams having the three different wavelengths to be input, the number of input ports is not limited to three and the optical coupler 100 can be configured to have two, four, or more input ports in correspondence with the number of visible light beams having different wavelengths.

Hereinafter, first, when visible light beams of three different wavelengths are coupled by a two-stage optical coupler, the order of coupling visible light of the longest wavelength, visible light of the second longest wavelength, and visible light of the shortest wavelength is described in the following three patterns;
a pattern in which the visible light of the longest wavelength and the visible light of the second longest wavelength are first coupled and the visible light of the shortest wavelength is subsequently coupled (first arrangement pattern (optical coupler of two-stage configuration)),
a pattern in which the visible light of the longest wavelength and the visible light of the shortest wavelength are first coupled and the visible light of the second longest wavelength is subsequently coupled (second arrangement pattern (optical coupler of two-stage configuration)), and
a pattern in which the visible light of the second longest wavelength and the visible light of the shortest wavelength are first coupled and the visible light of the longest wavelength is subsequently coupled (third arrangement pattern (optical coupler of two-stage configuration)).

### (First Arrangement Pattern (Optical Coupler of Two-Stage Configuration))

The first arrangement pattern is a pattern in which the visible light of the longest wavelength and the visible light of the second longest wavelength are first coupled and the visible light of the shortest wavelength is subsequently coupled.

A case where the visible light of the longest wavelength is the red light having a peak wavelength of 600 nm to 830 nm, the visible light of the second longest wavelength is the green light having a peak wavelength of 500 nm to 600 nm, and the visible light of the shortest wavelength is the blue light having a peak wavelength of 380 nm to 500 nm will be described as an example. The same is true for the second arrangement pattern and the third arrangement pattern.

In this case, in the optical coupler 100 shown in FIG. 1, the visible light input from the first light input port 21-1i is the red light having the peak wavelength of 600 nm to 830 nm, the visible light input from the second light input port 21-2i is the green light having the peak wavelength of 500 nm to 600 nm, and the visible light input from the third light input port 21-3i is the blue light having the peak wavelength of 380 nm to 500 nm.

In the optical coupler 100 shown in FIG. 1, the optical coupling portion 50 includes a first multimode-interference-type optical coupling portion 50A having two inputs and one output and a second multimode-interference-type optical coupling portion 50B having two inputs and one output, the optical waveguide 21-1 for the red light and the optical waveguide 21-2 for the green light are connected to light input sides 50Aa1 and 50Aa2 of the first multimode-interference-type optical coupling portion 50A, the optical waveguide 23 connected to the light output side 50Ab of the first multimode-interference-type optical coupling portion 50A and the optical waveguide 21-3 for the blue light are connected to light input sides 50Ba1 and 50Ba2 of the second multimode-interference-type optical coupling portion 50B, and the optical waveguide 22 connected to a light output side 50Bb of the second multimode-interference-type optical coupling portion 50B is connected to the light output port 22o.

In the optical coupler 100 shown in FIG. 1, a high-order mode removal portion 25-1 for the blue light is arranged in the optical waveguide 22 for connecting the light output side 50Bb of the second multimode-interference-type optical coupling portion 50B and the light output port 22o.

The blue light input from the third light input port 21-3i propagates through the optical waveguide 21-3 and is input to the second multimode-interference-type optical coupling portion 50B. The blue light input to the second multimode-interference-type optical coupling portion 50B is coupled with coupled light of the red light and the green light coupled by the first multimode-interference-type optical coupling portion 50A. Further, the blue light coupled with the coupled light of the red light and the green light is output from the second multimode-interference-type optical coupling portion 50B and passes through the high-order mode removal portion 25-3 for the blue light.

Here, the green light input from the second light input port 21-2i propagates through the optical waveguide 21-2, passes through the high-order mode removal portion 25-2 for the green light, and is subsequently input to the first multimode-interference-type optical coupling portion 50A. Also, the red light input from the first light input port 21-1i propagates through the optical waveguide 21-1, passes through the high-order mode removal portion 25-1 for the red light, and is subsequently input to the first multimode-interference-type optical coupling portion 50A.

Here, the red light input from the first light input port 21-1i passes through the high-order mode removal portion 25-1 for the red light and the high-order mode removal portion 25-3 for the blue light before being output from the light output port 22o. The green light input from the second light input port 21-2i also passes through the high-order mode removal portion 25-2 for the green light and the high-order mode removal portion 25-3 for the blue light before being output from the light output port 22o. Thus, both the red light and the green light are arranged to pass through only a high-order mode removal portion for visible light and a high-order mode removal portion for visible light having a shorter wavelength than the visible light.

On the other hand, the blue light input from the third light input port 21-3i passes through only the high-order mode removal portion 25-3 for the blue light without passing through a high-order mode removal portion for other visible light. Because the blue light has the shortest wavelength among the three visible light beams and visible light having a shorter wavelength than the blue light is not used, a configuration is adopted in which blue light does not pass through a high-order mode removal portion for visible light having a shorter wavelength than the blue light.

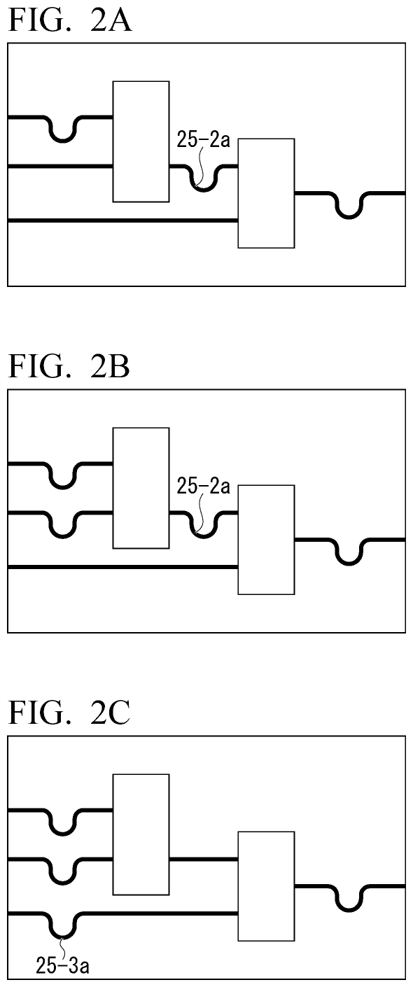

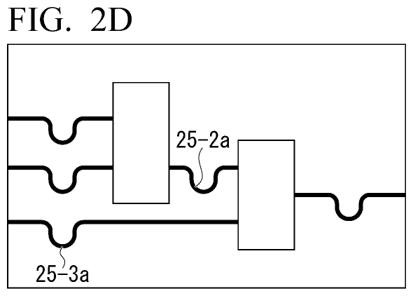

FIGS. 2A to 2D are examples of configurations in which only the arrangement of the optical coupler 100 and the high-order mode removal portion shown in FIG. 1 is different. Only the different parts are shown in a simplified manner. FIGS. 2A to 2D are identical to each other in that the high-order mode removal portion 25-3 for the blue light is arranged in the optical waveguide 22. In FIGS. 2A to 2D, reference signs for components identical to those of FIG. 1 are omitted.

In the optical coupler 100 shown in FIG. 1, the high-order mode removal portion 25-1 for the red light is arranged in the optical waveguide 21-1, the high-order mode removal portion 25-2 for the green light is arranged in the optical waveguide 21-2, and the high-order mode removal portion 25-3 for the blue light is arranged in the optical waveguide 22.

On the other hand, in the configuration example shown in FIG. 2A, the high-order mode removal portion for the green light is not arranged in the optical waveguide 21-2, but is arranged in the optical waveguide 23. The high-order mode removal portion for the green light arranged in the optical waveguide 23 is denoted by reference sign 25-2a.

Also, in the configuration example shown in FIG. 2B, the high-order mode removal portion for the green light is arranged in the optical waveguide 21-2 and the optical waveguide 23. In the configuration example shown in FIG. 2B, two high-order mode removal portions for the green light are provided.

In the configuration example shown in FIG. 2C, the high-order mode removal portion for the blue light is arranged in the optical waveguide 22 and the optical waveguide 21-3. The high-order mode removal portion for the blue light arranged in the optical waveguide 21-3 is denoted by reference sign 25-3a. In the configuration example shown in FIG. 2C, the two high-order mode removal portions for the blue light are provided.

Also, in the configuration example shown in FIG. 2D, a high-order mode removal portion for the blue light is arranged in the optical waveguide 22 and the optical waveguide 21-3 and the high-order mode removal portion for the green light is arranged in the optical waveguide 21-2 and the optical waveguide 23. In the configuration example shown in FIG. 2D, two high-order mode removal portions for the green light and two high-order mode removal portions for the blue light are provided.

In the configuration example shown in FIG. 2A, the green light input from the second light input port 21-2i propagates through the optical waveguide 21-2 and is input to the first multimode-interference-type optical coupling portion 50A. The green light is coupled with the red light and then coupled light passes through the high-order mode removal portion 25-2a for the green light arranged in the optical waveguide 23, and subsequently the coupled light is coupled with the blue light in the second multimode-interference-type optical coupling portion 50B and then passes through the high-order mode removal portion 25-3 for the blue light. Also, the red light input from the first light input port 21-1i propagates through the optical waveguide 21-1, passes through the high-order mode removal portion 25-1 for the red light, and is subsequently input to the first multimode-interference-type optical coupling portion 50A. Subsequently, the red light is coupled with the green light and then coupled light passes through the high-order mode removal portion 25-2a for the green light arranged in the optical waveguide 23, and subsequently, the coupled light is coupled with the blue light in the second multimode-interference-type optical coupling portion 50B and then passes through the high-order mode removal portion 25-3 for the blue light. The configuration example shown in FIG. 2A is the same as the configuration shown in FIG. 1 in that the blue light input from the third light input port 21-3i passes through only the high-order mode removal portion 25-3 for the blue light without passing through the high-order mode removal portion for other visible light.

As described above, the blue light of the shortest wavelength passes through only the high-order mode removal portion 25-3 for the blue light before being output from the light output port 22o. On the other hand, the red light passes through the high-order mode removal portion 25-1 for the red light, the high-order mode removal portion 25-2a for the green light having a shorter wavelength than the red light, and the high-order mode removal portion 25-3 for the blue light having a shorter wavelength than the red light before being output from the light output port 22o. Also, the green light passes through the high-order mode removal portion 25-2a for the green light and the high-order mode removal portion 25-3 for the blue light having a shorter wavelength than the green light before being output from the light output port 22o.

Thus, in the configuration example shown in FIG. 2A, a configuration is adopted in which the blue light passes through only the high-order mode removal portion for the blue light, the red light passes through the high-order mode removal portion for the red light and the high-order mode removal portions for the blue light and the green light having shorter wavelengths than the red light, and the green light passes through only the high-order mode removal portion for the green light and the high-order mode removal portion for the blue light having a shorter wavelength than the green light.

In the configuration example shown in FIG. 2B, the green light input from the second light input port 21-2i propagates through the optical waveguide 21-2, passes through the high-order mode removal portion 25-2 for the green light, and is subsequently input to the first multimode-interference-type optical coupling portion 50A. Subsequently, the green light is coupled with the red light and then coupled light passes through the high-order mode removal portion 25-2a for the green light arranged in the optical waveguide 23 and subsequently the coupled light is coupled with the blue light in the second multimode-interference-type optical coupling portion 50B and then passes through the high-order mode removal portion 25-3 for the blue light. Also, the red light input from the first light input port 21-1i propagates through the optical waveguide 21-1, passes through the high-order mode removal portion 25-1 for the red light, and is subsequently input to the first multimode-interference-type optical coupling portion 50A. Subsequently, the red light is coupled with the green light and then coupled light passes through the high-order mode removal portion 25-2a for the green light arranged in the optical waveguide 23 and subsequently, the coupled light is coupled with the blue light in the second multimode-interference-type optical coupling portion 50B and then passes through the high-order mode removal portion 25-3 for the blue light. The configuration example shown in FIG. 2A is the same as the configuration shown in FIG. 1 in that the blue light input from the third light input port 21-3i passes through only the high-order mode removal portion 25-3 for the blue light without passing through the high-order mode removal portion for other visible light.

As described above, the blue light of the shortest wavelength passes through only the high-order mode removal portion 25-3 for the blue light. On the other hand, the red light passes through the high-order mode removal portion 25-1 for the red light, the high-order mode removal portion 25-2a for the green light having a shorter wavelength than the red light, and the high-order mode removal portion 25-3 for the blue light having a shorter wavelength than the red light. Also, the green light passes through the high-order mode removal portion 25-2 for the green light, the high-order mode removal portion 25-2a for the green light, and the high-order mode removal portion 25-3 for the blue light having a shorter wavelength than green light.

Thus, in the configuration example shown in FIG. 2B, a configuration is adopted in which the blue light passes through only the high-order mode removal portion for the blue light, the red light passes through the high-order mode removal portion for the red light and the high-order mode removal portions for the blue light and the green light having a shorter wavelength than the red light, and the green light passes through only the high-order mode removal portion for the green light and the high-order mode removal portion for the blue light having a shorter wavelength than the green light.

In the configuration example shown in FIG. 2C, the green light input from the second light input port 21-2i propagates through the optical waveguide 21-2, passes through the high-order mode removal portion 25-2 for the green light, and is subsequently input to the first multimode-interference-type optical coupling portion 50A. Subsequently, the green light is coupled with the blue light in the second multimode-interference-type optical coupling portion 50B and then coupled light passes through the high-order mode removal portion 25-3 for the blue light. Also, the red light input from the first light input port 21-1i propagates through the optical waveguide 21-1, passes through the high-order mode removal portion 25-1 for the red light, and is subsequently input to the first multimode-interference-type optical coupling portion 50A. Subsequently, the red light is coupled with the blue light in the second multimode-interference-type optical coupling portion 50B and then coupled light passes through the high-order mode removal portion 25-3 for the blue light. The blue light input from the third light input port 21-3i passes through the high-order mode removal portion 25-3a for the blue light and subsequently the blue light is coupled with the red light and the green light in the second multimode-interference-type optical coupling portion 50B and then coupled light passes through the high-order mode removal portion 25-3 for the blue light.

As described above, the blue light of the shortest wavelength passes through only the high-order mode removal portions 25-3 and 25-3a for the blue light before being output from the light output port 22o. On the other hand, the red light passes through the high-order mode removal portion 25-1 for the red light and the high-order mode removal portion 25-3 for the blue light having a shorter wavelength than the red light before being output from the light output port 22o. Also, the green light passes through the high-order mode removal portion 25-2 for the green light and the high-order mode removal portion 25-3 for the blue light having a shorter wavelength than the green light before being output from the light output port 22o.

Thus, in the configuration example shown in FIG. 2C, a configuration is adopted in which the blue light passes through only the high-order mode removal portion for the blue light, the red light passes through the high-order mode removal portion for the red light and the high-order mode removal portion for the blue light having a shorter wavelength than the red light, and the green light passes through only the high-order mode removal portion for the green light and the high-order mode removal portion for the blue light having a shorter wavelength than the green light.

In the configuration example shown in FIG. 2D, the green light input from the second light input port 21-2i propagates through the optical waveguide 21-2, passes through the high-order mode removal portion 25-2 for the green light, and is subsequently input to the first multimode-interference-type optical coupling portion 50A. Subsequently, the green light is coupled with the red light and then coupled light passes through the high-order mode removal portion 25-2a for the green light arranged in the optical waveguide 23 and subsequently the coupled light is coupled with the blue light in the second multimode-interference-type optical coupling portion 50B and then the coupled light passes through the high-order mode removal portion 25-3 for the blue light. Also, the red light input from the first light input port 21-1i propagates through the optical waveguide 21-1, passes through the high-order mode removal portion 25-1 for the red light, and is subsequently input to the first multimode-interference-type optical coupling portion 50A. Subsequently, the red light is coupled with the green light and then coupled light passes through the high-order mode removal portion 25-2a for the green light arranged in the optical waveguide 23 and subsequently the coupled light is coupled with the blue light in the second multimode-interference-type optical coupling portion 50B and then the coupled light passes through the high-order mode removal portion 25-3 for the blue light. The blue light input from the third light input port 21-3i passes through the high-order mode removal portion 25-3a for the blue light and subsequently the blue light is coupled with the red light and the green light in the second multimode-interference-type optical coupling portion 50B and then coupled light passes through the high-order mode removal portion 25-3 for the blue light.

As described above, the blue light of the shortest wavelength passes through only the high-order mode removal portions 25-3 and 25-3a for the blue light before being output from the light output port 22o. On the other hand, the red light passes through the high-order mode removal portion 25-1 for the red light, the high-order mode removal portion 25-2a for the green light having a shorter wavelength than the red light, and the high-order mode removal portion 25-3 for the blue light having a shorter wavelength than the red light before being output from the light output port 22o. Also, the green light passes through the high-order mode removal portion 25-2 for the green light, the high-order mode removal portion 25-2a for the green light, and the high-order mode removal portion 25-3 for the blue light having a shorter wavelength than the green light before being output from the light output port 22o.

Thus, in the configuration example shown in FIG. 2D, a configuration is adopted in which the blue light passes through only the high-order mode removal portion for the blue light, the red light passes through the high-order mode removal portion for the red light and the high-order mode removal portions for the blue light and the green light having shorter wavelengths than the red light, and the green light passes through only the high-order mode removal portion for the green light and the high-order mode removal portion for the blue light having a shorter wavelength than the green light.

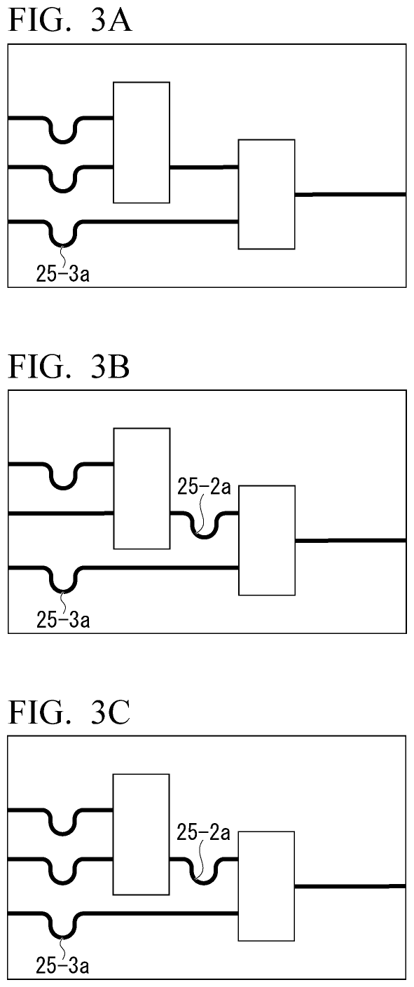

FIGS. 3A to 3C are examples of configurations different from the configuration shown in the optical coupler 100 shown in FIG. 1 and the configuration shown in FIGS. 2A to 2D in terms of only the arrangement of the high-order mode removal portions. Only the different parts are shown in a simplified manner. The arrangement of the high-order mode removal portion for the blue light in the optical waveguide 21-3 is the same in FIGS. 3A to 3C. In FIGS. 3A to 3C, reference signs of components identical to those of FIG. 1 are omitted. Also, when the arrangement of the high-order mode removal portions in FIGS. 3A to 3C is the same as that of FIGS. 2A to 2D, the high-order mode removal portions are denoted by reference signs identical to those of FIGS. 2A to 2D.

The configuration shown in FIG. 3A is identical to that of the optical coupler 100 shown in FIG. 1, except that the high-order mode removal portion for the blue light is not arranged in the optical waveguide 22 and is arranged in the optical waveguide 21-3.

The configuration shown in FIG. 3B is identical to that of the optical coupler 100 shown in FIG. 1, except that the high-order mode removal portion for the blue light is not arranged in the optical waveguide 22 but is arranged in the optical waveguide 21-3, and the high-order mode removal portion for the green light is not arranged in the optical waveguide 21-2 and is arranged in the optical waveguide 23.

The configuration shown in FIG. 3C is identical to that of the optical coupler 100 shown in FIG. 1, except that the high-order mode removal portion for the blue light is not arranged in the optical waveguide 22 but is arranged in the optical waveguide 21-3, and that the high-order mode removal portion for the green light is arranged in the optical waveguide 23 in addition to the optical waveguide 21-2.

In the configuration shown in FIG. 3A, the blue light input from the third light input port 21-3i propagates through the optical waveguide 21-3, passes through the high-order mode removal portion 25-3a for the blue light, and is input to the second multimode-interference-type optical coupling portion 50B. The blue light input to the second multimode-interference-type optical coupling portion 50B is coupled with the red light and the green light and coupled light is output from the light output port 22o. The green light input from the second light input port 21-2i propagates through the optical waveguide 21-2, passes through the high-order mode removal portion 25-2 for the green light, and is subsequently input to the first multimode-interference-type optical coupling portion 50A. Subsequently, the green light is coupled with the red light and is further coupled with the blue light in the second multimode-interference-type optical coupling portion 50B and then coupled light is output from the light output port 22o. The red light input from the first light input port 21-1i propagates through the optical waveguide 21-1, passes through the high-order mode removal portion 25-1 for the red light, and is subsequently input to the first multimode-interference-type optical coupling portion 50A. Subsequently, the red light is coupled with the green light and is further coupled with the blue light in the second multimode-interference-type optical coupling portion 50B and then coupled light is output from the light output port 22o.

As described above, the blue light of the shortest wavelength passes through only the high-order mode removal portion 25-3a for the blue light before being output from the light output port 22o. Also, the red light also passes through only the high-order mode removal portion 25-1 for the red light before being output from the light output port 22o. Also, the green light passes through only the high-order mode removal portion 25-2 for the green light before being output from the light output port 22o.

Thus, in the configuration example shown in FIG. 3A, a configuration is adopted in which the blue light passes through only the high-order mode removal portion for the blue light, the red light passes through only the high-order mode removal portion for the red light, and the green light passes through only the high-order mode removal portion for the green light.

In the configuration shown in FIG. 3B, the blue light input from the third light input port 21-3i propagates through the optical waveguide 21-3, passes through the high-order mode removal portion 25-3a for the blue light, and is input to the second multimode-interference-type optical coupling portion 50B. The blue light input to the second multimode-interference-type optical coupling portion 50B is coupled with the red light and the green light and coupled light is output from the light output port 22o. The green light input from the second light input port 21-2i propagates through the optical waveguide 21-2 and is input to the first multimode-interference-type optical coupling portion 50A. The green light is coupled with the red light and then coupled light passes through the high-order mode removal portion 25-2a for the green light arranged in the optical waveguide 23 and subsequently the coupled light is coupled with the blue light in the second multimode-interference-type optical coupling portion 50B and then the coupled light is output from the light output port 22o. The red light input from the first light input port 21-1i propagates through the optical waveguide 21-1 and the red light passes through the high-order mode removal portion 25-1 for the red light and then is input to the first multimode-interference-type optical coupling portion 50A. Subsequently, the red light is coupled with the green light and then coupled light passes through the high-order mode removal portion 25-2a for the green light arranged in the optical waveguide 23 and subsequently the coupled light is coupled with the blue light in the second multimode-interference-type optical coupling portion 50B and then the coupled light is output from the light output port 22o.

As described above, the blue light of the shortest wavelength passes through only the high-order mode removal portion 25-3a for the blue light before being output from the light output port 22o. Also, the red light also passes through the high-order mode removal portion 25-1 for the red light and the high-order mode removal portion 25-2a for the green light having a shorter wavelength than the red light before being output from the light output port 22o. Also, the green light passes through the high-order mode removal portion 25-2a for the green light and the high-order mode removal portion 25-3 for the blue light having a shorter wavelength than the green light before being output from the light output port 22o.

Thus, in the configuration example shown in FIG. 3B, a configuration is adopted in which the blue light passes through only the high-order mode removal portion for the blue light, the red light passes through only the high-order mode removal portion for the red light, and the green light passes through only the high-order mode removal portion for the green light.

In the configuration shown in FIG. 3C, the blue light input from the third light input port 21-3i propagates through the optical waveguide 21-3, passes through the high-order mode removal portion 25-3a for the blue light, and is input to the second multimode-interference-type optical coupling portion 50B. The blue light input to the second multimode-interference-type optical coupling portion 50B is coupled with the red light and the green light and coupled light is output from the light output port 22o. The green light input from the second light input port 21-2i passes through the high-order mode removal portion 25-2 for the green light and is subsequently input to the first multimode-interference-type optical coupling portion 50A. Subsequently, the green light is coupled with the red light and then coupled light passes through the high-order mode removal portion 25-2a for the green light arranged in the optical waveguide 23 and subsequently the coupled light is coupled with the blue light in the second multimode-interference-type optical coupling portion 50B and then the coupled light is output from the light output port 22o. The red light input from the first light input port 21-1i propagates through the optical waveguide 21-1 and the red light passes through the high-order mode removal portion 25-1 for the red light and then the red light is input to the first multimode-interference-type optical coupling portion 50A. Subsequently, the red light is coupled with the green light and then coupled light passes through the high-order mode removal portion 25-2a for the green light arranged in the optical waveguide 23 and subsequently the coupled light is coupled with the blue light in the second multimode-interference-type optical coupling portion 50B and then the coupled light is output from the light output port 22o.

As described above, the blue light of the shortest wavelength passes through only the high-order mode removal portion 25-3a for the blue light before being output from the light output port 22o. Also, the red light also passes through the high-order mode removal portion 25-1 for the red light and the high-order mode removal portion 25-2a for the green light having a shorter wavelength than the red light before being output from the light output port 22o. Also, the green light passes through only the high-order mode removal portions 25-2 and 25-2a for the green light before being output from the light output port 22o.

Thus, in the configuration example shown in FIG. 3C, a configuration is adopted in which the blue light passes through only the high-order mode removal portion for the blue light, the red light passes through only the high-order mode removal portion for the red light and the high-order mode removal portion for the green light having a shorter wavelength than the red light, and the green light passes through only the high-order mode removal portion for the green light.

### (Second Arrangement Pattern (Optical Coupler of Two-Stage Configuration))

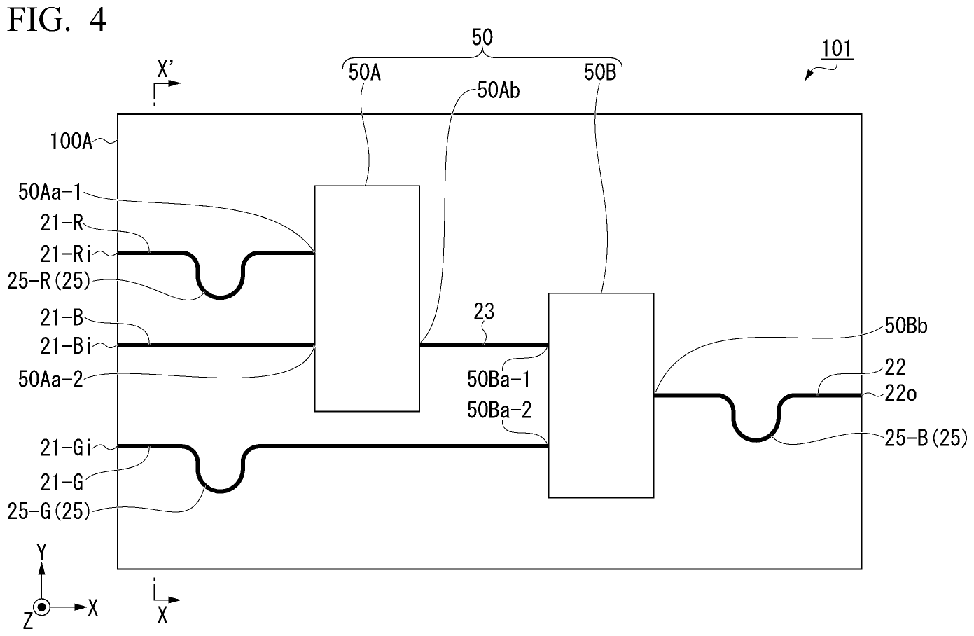

The second arrangement pattern is a pattern in which the visible light of the longest wavelength and the visible light of the shortest wavelength are first coupled and then the visible light of the second longest wavelength is coupled. In FIG. 4, a schematic plan view of an optical coupler according to the second arrangement pattern is shown.

The optical coupler 101 shown in FIG. 4 is identical to the optical coupler of the first arrangement pattern in that the optical coupling portion 50 includes a first multimode-interference-type optical coupling portion 50A having two inputs and one output and a second multimode-interference-type optical coupling portion 50B having two inputs and one output. On the other hand, there are the following differences.

An optical waveguide 21-R for the red light and an optical waveguide 21-R for the blue light are connected to the light input sides 50Aa1 and 50Aa2 of the first multimode-interference-type optical coupling portion 50A, the optical waveguide 23 connected to the light output side 50Ab of the first multimode-interference-type optical coupling portion 50A and the optical waveguide 21-G for the green light are connected to the light input sides 50Ba1 and 50Ba2 of the second multimode-interference-type optical coupling portion 50B, and the optical waveguide 22 connected to the light output side 50Bb of the second multimode-interference-type optical coupling portion 50B is connected to the light output port 22o.

The optical coupler 101 shown in FIG. 4 is identical to the optical coupler 100 shown in FIG. 1 in that the high-order mode removal portion 25-1 for the blue light is arranged in the optical waveguide 22 for connecting the light output side 50Bb of the second multimode-interference-type optical coupling portion 50B and the light output port 22o.

The blue light input from the second light input port 21-Bi propagates through the optical waveguide 21-B and is input to the first multimode-interference-type optical coupling portion 50A and coupled with the red light. The blue light coupled with the red light is coupled with the green light in the second multimode-interference-type optical coupling portion 50B, subsequently coupled light passes through the high-order mode removal portion 25-B for the blue light, and is subsequently output from the light output port 22o. The red light input from a first light input port 21-Ri propagates through the optical waveguide 21-R, passes through the high-order mode removal portion 25-R for the red light, and is subsequently input to the first multimode-interference-type optical coupling portion 50A and coupled with the blue light. The red light coupled with the blue light is coupled with the green light in the second multimode-interference-type optical coupling portion 50B, subsequently coupled light passes through the high-order mode removal portion 25-B for the blue light, and is subsequently output from the light output port 22o. The green light input from a second light input port 21-Gi propagates through the optical waveguide 21-G and passes through a high-order mode removal portion 25-G for the green light. Subsequently, the green light is coupled with coupled light obtained by coupling the red light and the blue light in the second multimode-interference-type optical coupling portion 50B, and the coupled light passes through the high-order mode removal portion 25-B for the blue light and is subsequently output from the light output port 22o.

As described above, the blue light of the shortest wavelength passes through only the high-order mode removal portion 25-B for the blue light before being output from the light output port 22o. On the other hand, the red light passes through the high-order mode removal portion 25-R for the red light and the high-order mode removal portion 25-B for the blue light having a shorter wavelength than the red light before being output from the light output port 22o. Also, the green light passes through the high-order mode removal portion 25-G for the green light and the high-order mode removal portion 25-B for the blue light having a shorter wavelength than the green light before being output from the light output port 22o.

Thus, the optical coupler 101 shown in FIG. 4 is configured so that the blue light passes through only the high-order mode removal portion for the blue light and the red light and the green light pass through only the high-order mode removal portion for the visible light and a high-order mode removal portion for visible light having a shorter wavelength than the visible light.

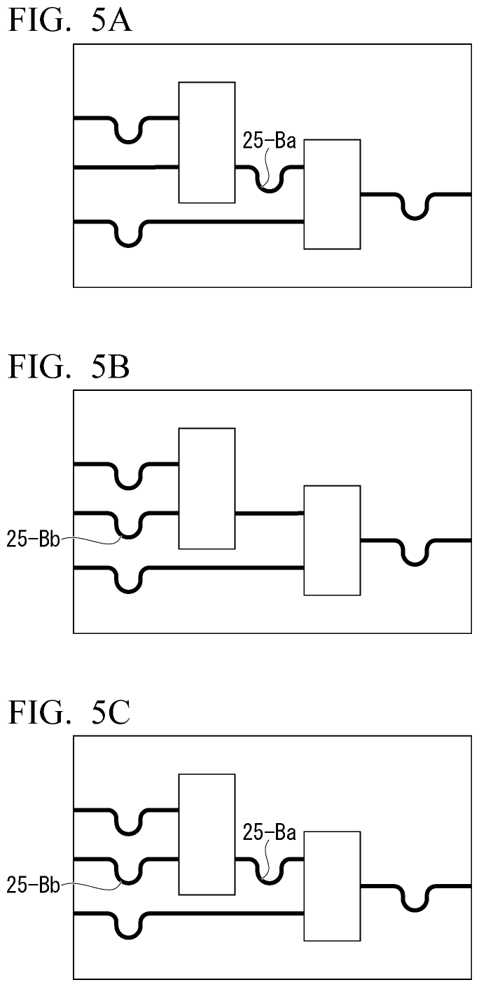

FIGS. 5A to 5C are examples of configurations in which only the arrangement of the high-order mode removal portions is different from that of the optical coupler 101 shown in FIG. 4. Only the different parts are shown in a simplified manner. FIGS. 5A to 5C are identical to each other in that the high-order mode removal portion 25-B for the blue light is arranged in the optical waveguide 22. In FIGS. 5A to 5C, reference signs of components identical to those of FIG. 4 are omitted.

In the configuration example shown in FIG. 5A, the high-order mode removal portion for the blue light is arranged in the optical waveguide 22 and the optical waveguide 23. The high-order mode removal portion for the blue light arranged in the optical waveguide 23 is denoted by reference sign 25-Ba. In the configuration example shown in FIG. 5A, two high-order mode removal portions for the blue light are provided.

Also, in the configuration example shown in FIG. 5B, the high-order mode removal portion for the blue light is arranged in the optical waveguide 22 and the optical waveguide 21-B. The high-order mode removal portion for the blue light arranged in the optical waveguide 21-B is denoted by reference sign 25-Bb. In the configuration example shown in FIG. 5B, two high-order mode removal portions for the blue light are provided.

Also, in the configuration example shown in FIG. 5C, the high-order mode removal portion for the blue light is arranged in the optical waveguide 22, the optical waveguide 23, and the optical waveguide 21-B. In the configuration example shown in FIG. 5C, three high-order mode removal portions for the blue light are provided.

In the configuration example shown in FIG. 5A, the blue light input from the second light input port 21-Bi propagates through the optical waveguide 21-B and is input to the first multimode-interference-type optical coupling portion 50A and coupled with the red light. The blue light coupled with the red light passes through the high-order mode removal portion 25-Ba for the blue light arranged in the optical waveguide 23. Subsequently, the coupled light is coupled with the green light in the second multimode-interference-type optical coupling portion 50B, the coupled light passes through the high-order mode removal portion 25-B for the blue light, and is output from the light output port 22o. Also, the red light input from the first light input port 21-Ri propagates through the optical waveguide 21-R, passes through the high-order mode removal portion 25-R for the red light, and is subsequently input to the first multimode-interference-type optical coupling portion 50A and coupled with the blue light. Subsequently, coupled light passes through the high-order mode removal portion 25-Ba for the blue light arranged in the optical waveguide 23 and is subsequently coupled with the green light in the second multimode-interference-type optical coupling portion 50B. Subsequently, the coupled light passes through the high-order mode removal portion 25-B for the blue light and is output from the light output port 22o. Also, the green light input from the second light input port 21-Gi propagates through the optical waveguide 21-G and passes through the high-order mode removal portion 25-G for the green light. Subsequently, the green light is coupled with coupled light obtained by coupling the red light and the blue light in the second multimode-interference-type optical coupling portion 50B, and the coupled light subsequently passes through the high-order mode removal portion 25-B for the blue light and is subsequently output from the light output port 22o.

As described above, the blue light of the shortest wavelength passes through only the high-order mode removal portions 25-B and 25-Ba for the blue light before being output from the light output port 22o. On the other hand, the red light passes through the high-order mode removal portion 25-R for the red light and the high-order mode removal portions 25-B and 25-Ba for the blue light having a shorter wavelength than the red light before being output from the light output port 22o. Also, the green light passes through the high-order mode removal portion 25-G for the green light and the high-order mode removal portion 25-B for the blue light having a shorter wavelength than the green light before being output from the light output port 22o.

Thus, in the configuration example shown in FIG. 5A, a configuration is adopted in which the blue light passes through only the high-order mode removal portion for the blue light and the red light and the green light pass through only the high-order mode removal portion for the visible light and a high-order mode removal portion for visible light having a shorter wavelength than the visible light.

In the configuration example shown in FIG. 5B, the blue light input from the second light input port 21-Bi propagates through the optical waveguide 21-B, passes through the high-order mode removal portion 25-Bb for the blue light arranged in the optical waveguide 21-B, and is input to the first multimode-interference-type optical coupling portion 50A and coupled with the red light. The blue light coupled with the red light is subsequently coupled with the green light in the second multimode-interference-type optical coupling portion 50B, and then the coupled light passes through the high-order mode removal portion 25-B for the blue light and is output from the light output port 22o.

Also, the red light input from the first light input port 21-Ri propagates through the optical waveguide 21-R, passes through the high-order mode removal portion 25-R for the red light, and is subsequently input to the first multimode-interference-type optical coupling portion 50A and coupled with the blue light. Subsequently, coupled light is coupled with the green light in the second multimode-interference-type optical coupling portion 50B. Subsequently, the coupled light passes through the high-order mode removal portion 25-B for the blue light and is output from the light output port 22o.

Also, the green light input from the second light input port 21-Gi propagates through the optical waveguide 21-G and passes through the high-order mode removal portion 25-G for the green light. Subsequently, the green light is coupled with coupled light obtained by coupling the red light and the blue light in the second multimode-interference-type optical coupling portion 50B, and the coupled light subsequently passes through the high-order mode removal portion 25-B for the blue light and is output from the light output port 22o.

As described above, the blue light of the shortest wavelength passes through only the high-order mode removal portions 25-B and 25-Bb for the blue light before being output from the light output port 22o. On the other hand, the red light passes through the high-order mode removal portion 25-R for the red light and the high-order mode removal portion 25-B for the blue light having a shorter wavelength than the red light before being output from the light output port 22o. Also, the green light passes through the high-order mode removal portion 25-G for the green light and the high-order mode removal portion 25-B for the blue light having a shorter wavelength than the green light before being output from the light output port 22o.

Thus, in the configuration example shown in FIG. 5B, a configuration is adopted in which the blue light passes through only the high-order mode removal portion for the blue light and the red light and the green light pass through only the high-order mode removal portion for the visible light and a high-order mode removal portion for visible light having a shorter wavelength than the visible light.

In the configuration example shown in FIG. 5C, the blue light input from the second light input port 21-Bi propagates through the optical waveguide 21-B, passes through the high-order mode removal portion 25-Bb for the blue light arranged in the optical waveguide 21-B, and is input to the first multimode-interference-type optical coupling portion 50A and coupled with the red light. The blue light coupled with the red light passes through the high-order mode removal portion 25-Ba for the blue light arranged in the optical waveguide 23. Subsequently, the coupled light is coupled with the green light in the second multimode-interference-type optical coupling portion 50B, subsequently passes through the high-order mode removal portion 25-B for the blue light, and is output from the light output port 22o. Also, the red light input from the first light input port 21-Ri propagates through the optical waveguide 21-R, passes through the high-order mode removal portion 25-R for the red light, and is subsequently input to the first multimode-interference-type optical coupling portion 50A and coupled with the blue light. Subsequently, coupled light passes through the high-order mode removal portion 25-Ba for the blue light arranged in the optical waveguide 23 and is subsequently coupled with the green light in the second multimode-interference-type optical coupling portion 50B. Subsequently, the coupled light passes through the high-order mode removal portion 25-B for the blue light and is output from the light output port 22o. Also, the green light input from the second light input port 21-Gi propagates through the optical waveguide 21-G and passes through the high-order mode removal portion 25-G for the green light. Subsequently, the green light is coupled with coupled light obtained by coupling the red light and the blue light in the second multimode-interference-type optical coupling portion 50B, and the coupled light passes through the high-order mode removal portion 25-B for the blue light and is subsequently output from the light output port 22o.

As described above, the blue light of the shortest wavelength passes through only the high-order mode removal portions 25-B, 25-Ba, and 25-Bb for the blue light before being output from the light output port 22o. On the other hand, the red light passes through the high-order mode removal portion 25-R for the red light and the high-order mode removal portion 25-B for the blue light having a shorter wavelength than the red light before being output from the light output port 22o. Also, the green light passes through the high-order mode removal portion 25-G for the green light and the high-order mode removal portion 25-B for the blue light having a shorter wavelength than the green light before being output from the light output port 22o.

Thus, in the configuration example shown in FIG. 5C, a configuration is adopted in which the blue light passes through only the high-order mode removal portion for the blue light and the red light and the green light pass through only the high-order mode removal portion for the visible light and a high-order mode removal portion for visible light having a shorter wavelength than the visible light.

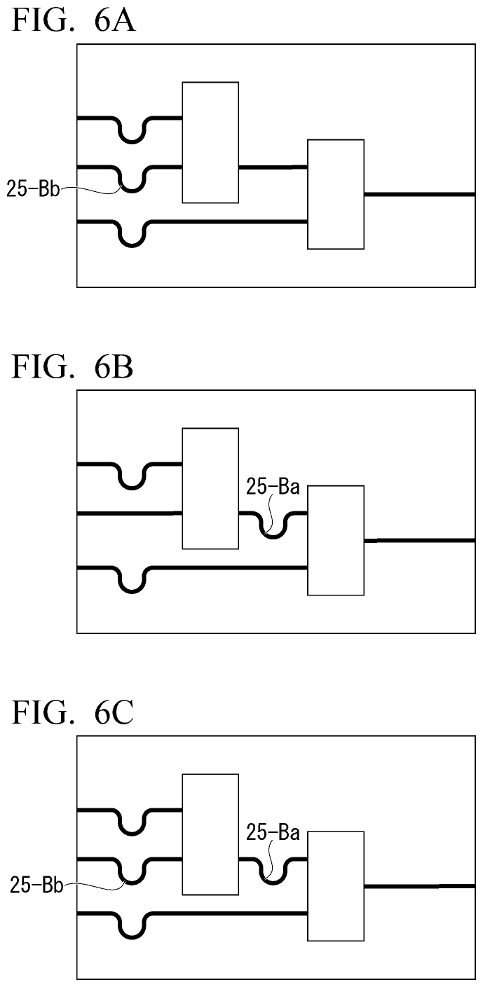

FIGS. 6A to 6C are examples of configurations in which only the arrangement of the high-order mode removal portions is different from those of the optical coupler 101 shown in FIG. 4 and the configurations of FIGS. 5A to 5C. Only the different parts are shown in a simplified manner. FIGS. 6A to 6C are identical to each other in that the high-order mode removal portion for the green light is arranged in the optical waveguide 21-G. In FIGS. 6A to 6C, reference signs of components identical to those of FIG. 4 are omitted. Also, when the arrangement of the high-order mode removal portions in FIGS. 6A to 6C is the same as that in FIGS. 5A to 5C, the high-order mode removal portions are denoted by the same reference signs as those in FIGS. 5A to 5C.

The configuration shown in FIG. 6A is identical to the configuration of the optical coupler 101 shown in FIG. 4, except that the high-order mode removal portion for the blue light is not arranged in the optical waveguide 22 and is arranged in the optical waveguide 21-B.

The configuration shown in FIG. 6B is identical to the configuration of the optical coupler 101 shown in FIG. 4, except that the high-order mode removal portion for the blue light is not arranged in the optical waveguide 22 and is arranged in the optical waveguide 23.

The configuration shown in FIG. 6C is identical to the configuration of the optical coupler 101 shown in FIG. 4, except that the high-order mode removal portion for the blue light is not arranged in the optical waveguide 22 and is arranged in the optical waveguide 21-B and the optical waveguide 23.

In the configuration shown in FIG. 6A, the blue light input from the second light input port 21-Bi propagates through the optical waveguide 21-B, passes through the high-order mode removal portion 25-Bb for the blue light, and is input to the first multimode-interference-type optical coupling portion 50A. Subsequently, after the blue light is coupled with the red light and further coupled with the green light in the second multimode-interference-type optical coupling portion 50B, the coupled light passes through the high-order mode removal portion 25-B for the blue light and is output from the light output port 22o. The red light input from the first light input port 21-Ri propagates through the optical waveguide 21-R, passes through the high-order mode removal portion 25-R for the red light, and then is input to the first multimode-interference-type optical coupling portion 50A. Subsequently, after the red light is coupled with blue light and coupled with the green light in the second multimode-interference-type optical coupling portion 50B, the coupled light passes through the high-order mode removal portion 25-B for the blue light and is output from the light output port 22o. The green light input from the second light input port 21-Gi propagates through the optical waveguide 21-G, passes through the high-order mode removal portion 25-G for the green light, and is subsequently coupled with coupled light obtained by coupling the red light and the blue light in the second multimode-interference-type optical coupling portion 50B. Subsequently, the coupled light passes through the high-order mode removal portion 25-B for the blue light and is output from the light output port 22o.

As described above, the blue light of the shortest wavelength passes through only the high-order mode removal portion 25-Bb for the blue light before being output from the light output port 22o. Also, the red light passes through only the high-order mode removal portion 25-R for the red light before being output from the light output port 22o. Also, the green light passes through only the high-order mode removal portion 25-G for the green light before being output from the light output port 22o.

Thus, in the configuration example shown in FIG. 6A, a configuration is adopted in which the blue light passes through only the high-order mode removal portion for the blue light, the red light passes only the high-order mode removal portion for the red light, and the green light passes through only the high-order mode removal portion for the green light.

In the configuration shown in FIG. 6B, the blue light input from the second light input port 21-Bi propagates through the optical waveguide 21-B and is input to the first multimode-interference-type optical coupling portion 50A. After the blue light is coupled with the red light in the first multimode-interference-type optical coupling portion 50A, the coupled light passes through the high-order mode removal portion 25-Ba for the blue light arranged in the optical waveguide 23. After the coupled light is coupled with the green light in the second multimode-interference-type optical coupling portion 50B, the coupled light passes through the high-order mode removal portion 25-B for the blue light and is output from the light output port 22o. The red light input from the first light input port 21-Ri propagates through the optical waveguide 21-R, passes through the high-order mode removal portion 25-R for the red light, and is subsequently input to the first multimode-interference-type optical coupling portion 50A and coupled with the blue light. Subsequently, the red light coupled with the blue light passes through the high-order mode removal portion 25-Ba for the blue light arranged in the optical waveguide 23 and is subsequently coupled with the green light in the second multimode-interference-type optical coupling portion 50B. Subsequently, the coupled light passes through the high-order mode removal portion 25-B for the blue light and is output from the light output port 22o. The green light input from the second light input port 21-Gi propagates through the optical waveguide 21-G, passes through the high-order mode removal portion 25-G for the green light, and is coupled with coupled light obtained by coupling the red light and the blue light in the second multimode-interference-type optical coupling portion 50B. Subsequently, the coupled light passes through the high-order mode removal portion 25-B for the blue light and is output from the light output port 22o.

As described above, the blue light of the shortest wavelength passes through only the high-order mode removal portion 25-Ba for the blue light before being output from the light output port 22o. Also, the red light passes through the high-order mode removal portion 25-R for the red light and the high-order mode removal portion 25-Ba for the blue light having a shorter wavelength than the red light before being output from the light output port 22o. Also, the green light passes through only the high-order mode removal portion 25-G for the green light before being output from the light output port 22o.

Thus, in the configuration example shown in FIG. 6B, a configuration is adopted in which the blue light passes only the high-order mode removal portion for the blue light, the red light passes through only the high-order mode removal portion for the red light and the high-order mode removal portion for the blue light having a shorter wavelength than the red light, and the green light passes through only the high-order mode removal portion for the green light.

In the configuration shown in FIG. 6C, the blue light input from the second light input port 21-Bi propagates through the optical waveguide 21-3, passes through the high-order mode removal portion 25-Bb for the blue light, and is input to the first multimode-interference-type optical coupling portion 50A. Subsequently, after the blue light is coupled with the red light in the first multimode-interference-type optical coupling portion 50A, the coupled light passes through the high-order mode removal portion 25-Ba for the blue light arranged in the optical waveguide 23. After the coupled light is coupled with the green light in the second multimode-interference-type optical coupling portion 50B, the coupled light passes through the high-order mode removal portion 25-B for the blue light and is output from the light output port 22o. The red light input from the first light input port 21-Ri propagates through the optical waveguide 21-R, passes through the high-order mode removal portion 25-R for the red light, and is subsequently input to the first multimode-interference-type optical coupling portion 50A and coupled with the blue light. Subsequently, the red light coupled with the blue light passes through the high-order mode removal portion 25-Ba for the blue light arranged in the optical waveguide 23 and is subsequently coupled with the green light in the second multimode-interference-type optical coupling portion 50B. Subsequently, the coupled light passes through the high-order mode removal portion 25-B for the blue light and is output from the light output port 22o. The green light input from the second light input port 21-Gi propagates through the optical waveguide 21-G, passes through the high-order mode removal portion 25-G for the green light, and is coupled with coupled light obtained by coupling the red light and the blue light in the second multimode-interference-type optical coupling portion 50B. Subsequently, the coupled light passes through the high-order mode removal portion 25-B for the blue light and is output from the light output port 22o.

As described above, the blue light of the shortest wavelength passes through only the high-order mode removal portions 25-Ba and 25Bb for the blue light before being output from the light output port 22o. Also, the red light passes through the high-order mode removal portion 25-R for the red light and the high-order mode removal portion 25-Ba for the blue light having a shorter wavelength than the red light before being output from the light output port 22o. Also, the green light passes through only the high-order mode removal portion 25-G for the green light before being output from the light output port 22o.

Thus, in the configuration example shown in FIG. 6C, a configuration in which the blue light passes only the high-order mode removal portion for the blue light, the red light passes through only the high-order mode removal portion for the red light and the high-order mode removal portion for the blue light having a shorter wavelength than the red light, and the green light passes through only the high-order mode removal portion for the green light is adopted.

### (Third Arrangement Pattern (Optical Coupler of Two-Stage Configuration))

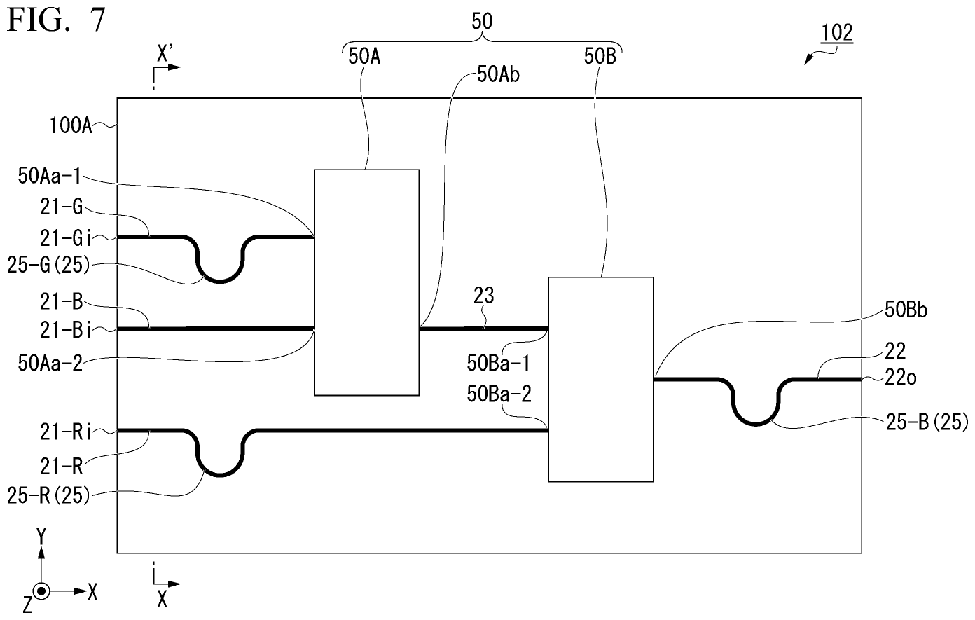

The third arrangement pattern is a pattern in which visible light of the second longest wavelength and visible light of the shortest wavelength are first coupled and visible light of the longest wavelength is subsequently coupled. In FIG. 7, a schematic plan view of an optical coupler according to the third arrangement pattern is shown.

The optical coupler 102 shown in FIG. 7 is identical to the optical coupler of the first arrangement pattern and the optical coupler of the second arrangement pattern in that the optical coupling portion 50 includes a first multimode-interference-type optical coupling portion 50A having two inputs and one output and a second multimode-interference-type optical coupling portion 50B having two inputs and one output. On the other hand, there are the following differences.

An optical waveguide 21-G for the green light and an optical waveguide 21-R for the blue light are connected to the light input sides 50Aa1 and 50Aa2 of the first multimode-interference-type optical coupling portion 50A, the optical waveguide 23 connected to the light output side 50Ab of the first multimode-interference-type optical coupling portion 50A and the optical waveguide 21-R for the red light are connected to the light input sides 50Ba1 and 50Ba2 of the second multimode-interference-type optical coupling portion 50B, and the optical waveguide 22 connected to the light output side 50Bb of the second multimode-interference-type optical coupling portion 50B is connected to the light output port 22o.

The optical coupler 102 shown in FIG. 7 is identical to the optical coupler 100 shown in FIG. 1 and the optical coupler 101 shown in FIG. 4 in that the high-order mode removal portion 25-1 for the blue light is arranged in the optical waveguide 22 for connecting the light output side 50Bb of the second multimode-interference-type optical coupling portion 50B and the light output port 22o.

The blue light input from the second light input port 21-Bi propagates through the optical waveguide 21-B and is input to the first multimode-interference-type optical coupling portion 50A and coupled with the green light. The blue light coupled with the green light is coupled with the red light in the second multimode-interference-type optical coupling portion 50B, subsequently coupled light passes through the high-order mode removal portion 25-B for the blue light, and is subsequently output from the light output port 22o. The green light input from the first light input port 21-Gi propagates through the optical waveguide 21-G, passes through the high-order mode removal portion 25-G for the green light, and is subsequently input to the first multimode-interference-type optical coupling portion 50A and coupled with the blue light. The green light coupled with the blue light is coupled with the red light in the second multimode-interference-type optical coupling portion 50B, coupled light passes through the high-order mode removal portion 25-B for the blue light, and is subsequently output from the light output port 22o. The red light input from the second light input port 21-Ri propagates through the optical waveguide 21-G and passes through the high-order mode removal portion 25-R for the green light. Subsequently, the red light is coupled with coupled light obtained by coupling the green light and the blue light in the second multimode-interference-type optical coupling portion 50B, and the coupled light passes through the high-order mode removal portion 25-B for the blue light and is subsequently output from the light output port 22o.

As described above, the blue light of the shortest wavelength passes through only the high-order mode removal portion 25-B for the blue light before being output from the light output port 22o. On the other hand, the red light passes through the high-order mode removal portion 25-R for the red light and the high-order mode removal portion 25-B for the blue light having a shorter wavelength than the red light before being output from the light output port 22o. Also, the green light passes through the high-order mode removal portion 25-G for the green light and the high-order mode removal portion 25-B for the blue light having a shorter wavelength than the green light before being output from the light output port 22o.

Thus, the optical coupler 102 shown in FIG. 7 is configured so that the blue light passes through only the high-order mode removal portion for the blue light and the red light and the green light pass through only the high-order mode removal portion for the visible light and a high-order mode removal portion for visible light having a shorter wavelength than the visible light.

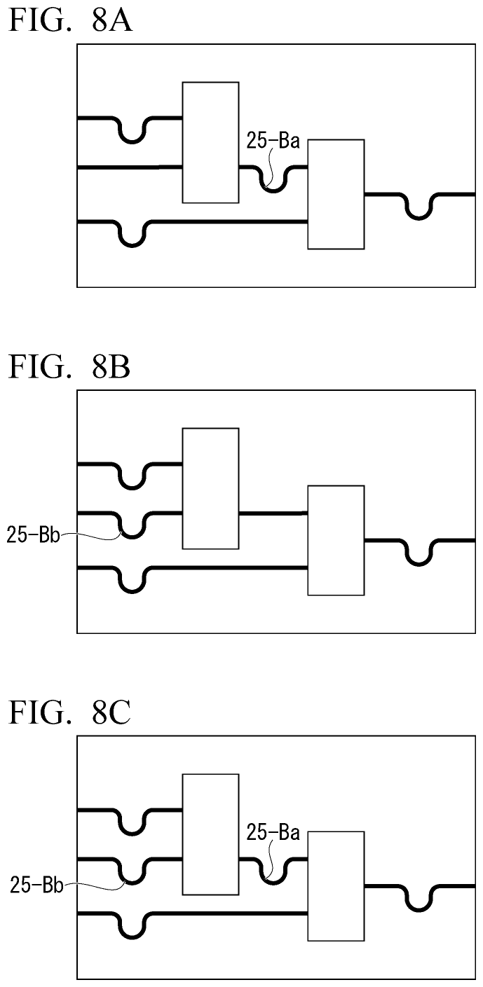

FIGS. 8A to 8C are examples of configurations in which only the arrangement of the high-order mode removal portions is different from those of the optical coupler 102 shown in FIG. 7. Only the different parts are shown in a simplified manner. FIGS. 8A to 8C are identical to each other in that the high-order mode removal portion 25-B for the blue light is arranged in the optical waveguide 22. In FIGS. 8A to 8C, reference signs of components identical to those of FIG. 7 are omitted.

In the configuration example shown in FIG. 8A, the high-order mode removal portion for the blue light is arranged in the optical waveguide 22 and the optical waveguide 23. The high-order mode removal portion for the blue light arranged in the optical waveguide 23 is denoted by reference sign 25-Ba. In the configuration example shown in FIG. 8A, two high-order mode removal portions for the blue light are provided.

Also, in the configuration example shown in FIG. 8B, the high-order mode removal portion for the blue light is arranged in the optical waveguide 22 and the optical waveguide 21-B. The high-order mode removal portion for the blue light arranged in the optical waveguide 21-B is denoted by reference sign 25-Bb. In the configuration example shown in FIG. 8B, two high-order mode removal portions for the blue light are provided.

Also, in the configuration example shown in FIG. 8C, the high-order mode removal portion for the blue light is arranged in the optical waveguide 22, the optical waveguide 23, and the optical waveguide 21-B. In the configuration example shown in FIG. 8C, three high-order mode removal portions for the blue light are provided.

In the configuration example shown in FIG. 8A, the blue light input from the second light input port 21-Bi propagates through the optical waveguide 21-B and is input to the first multimode-interference-type optical coupling portion 50A and coupled with the green light. The blue light coupled with the green light passes through the high-order mode removal portion 25-Ba for the blue light arranged in the optical waveguide 23. Subsequently, after the coupled light is coupled with the red light in the second multimode-interference-type optical coupling portion 50B, the coupled light passes through the high-order mode removal portion 25-B for the blue light and is output from the light output port 22o. Also, the green light input from the second light input port 21-Gi propagates through the optical waveguide 21-G, passes through the high-order mode removal portion 25-G for the green light, and is subsequently input to the first multimode-interference-type optical coupling portion 50A and coupled with the blue light. The green light coupled with the blue light subsequently passes through the high-order mode removal portion 25-Ba for the blue light arranged in the optical waveguide 23 and is subsequently coupled with the red light in the second multimode-interference-type optical coupling portion 50B. The coupled light passes through the high-order mode removal portion 25-B for the blue light and is output from the light output port 22o. Also, the red light input from the first light input port 21-Ri propagates through the optical waveguide 21-R, passes through the high-order mode removal portion 25-R for the red light, and is subsequently coupled with coupled light obtained by coupling the green light and the blue light in the second multimode-interference-type optical coupling portion 50B. Subsequently, the coupled light passes through the high-order mode removal portion 25-B for the blue light and is output from the light output port 22o.

As described above, the blue light of the shortest wavelength passes through only the high-order mode removal portions 25-B and 25-Ba for blue light before being output from the light output port 22o. On the other hand, the green light passes through the high-order mode removal portion 25-G for the green light and the high-order mode removal portions 25-B and 25-Ba for the blue light having a shorter wavelength than the green light before being output from the light output port 22o. Also, the red light passes through the high-order mode removal portion 25-R for the red light and the high-order mode removal portion 25-B for the blue light having a shorter wavelength than the red light before being output from the light output port 22o.

Thus, in the configuration example shown in FIG. 8A, a configuration is adopted in which the blue light passes through only the high-order mode removal portion for the blue light and the red light and the green light pass through the high-order mode removal portion for the visible light and a high-order mode removal portion for visible light having a shorter wavelength than the visible light.

In the configuration example shown in FIG. 8B, the blue light input from the second light input port 21-Bi propagates through the optical waveguide 21-B, passes through the high-order mode removal portion 25-Bb for the blue light arranged in the optical waveguide 21-B, and is input to the first multimode-interference-type optical coupling portion 50A and coupled with the green light. After the blue light coupled with the green light is subsequently coupled with the red light in the second multimode-interference-type optical coupling portion 50B, the coupled light passes through the high-order mode removal portion 25-B for the blue light and is output from the light output port 22o.

Also, the green light input from the second light input port 21-Gi propagates through the optical waveguide 21-G, passes through the high-order mode removal portion 25-G for the green light, and is subsequently input to the first multimode-interference-type optical coupling portion 50A and coupled with the blue light. After the green light coupled with the blue light is coupled with the red light in the second multimode-interference-type optical coupling portion 50B, the coupled light passes through the high-order mode removal portion 25-B for the blue light, and is output from the light output port 22o. Also, the red light input from the first light input port 21-Ri propagates through the optical waveguide 21-R, passes through the high-order mode removal portion 25-R for the red light, and is subsequently coupled with coupled light obtained by coupling the green light and the blue light in the second multimode-interference-type optical coupling portion 50B. Subsequently, the coupled light passes through the high-order mode removal portions 25-B for the blue light and is output from the light output port 22o.

As described above, the blue light of the shortest wavelength passes through only the high-order mode removal portions 25-B and 25-Bb for the blue light before being output from the light output port 22o. On the other hand, the green light passes through the high-order mode removal portion 25-G for the green light and the high-order mode removal portion 25-B for the blue light having a shorter wavelength than the green light before being output from the light output port 22o. Also, the red light passes through the high-order mode removal portion 25-R for the red light and the high-order mode removal portion 25-B for the blue light having a shorter wavelength than the red light before being output from the light output port 22o.

Thus, in the configuration example shown in FIG. 8B, a configuration is adopted in which the blue light passes through only the high-order mode removal portion for the blue light and the red light and the green light pass through the high-order mode removal portion for the visible light and a high-order mode removal portion for visible light having a shorter wavelength than the visible light.

In the configuration example shown in FIG. 8C, the blue light input from the second light input port 21-Bi propagates through the optical waveguide 21-B, passes through the high-order mode removal portion 25-Bb for the blue light arranged in the optical waveguide 21-B, and is input to the first multimode-interference-type optical coupling portion 50A and coupled with the green light. The blue light coupled with the green light passes through the high-order mode removal portion 25-Ba for the blue light arranged in the optical waveguide 23. Subsequently, after the coupled light is coupled with the red light in the second multimode-interference-type optical coupling portion 50B, the coupled light passes through the high-order mode removal portion 25-B for the blue light and is output from the light output port 22o. Also, the green light input from the second light input port 21-Gi propagates through the optical waveguide 21-G, passes through the high-order mode removal portion 25-G for the green light, and is subsequently input to the first multimode-interference-type optical coupling portion 50A and coupled with the blue light. The green light coupled with the blue light passes through the high-order mode removal portion 25-Ba for the blue light arranged in the optical waveguide 23 and is subsequently coupled with the red light in the second multimode-interference-type optical coupling portion 50B. Subsequently, the coupled light passes through the high-order mode removal portion 25-B for the blue light and is output from the light output port 22o. Also, the red light input from the first light input port 21-Ri propagates through the optical waveguide 21-R, passes through the high-order mode removal portion 25-R for the red light, and is subsequently coupled with coupled light obtained by coupling the green light and the blue light in the second multimode-interference-type optical coupling portion 50B. Subsequently, the coupled light passes through the high-order mode removal portion 25-B for the blue light and is output from the light output port 22o.

As described above, the blue light of the shortest wavelength passes through only the high-order mode removal portions 25-B, 25-Ba, and 25-Bb for blue light before being output from the light output port 22o. On the other hand, the green light passes through the high-order mode removal portion 25-G for the green light and the high-order mode removal portions 25-Ba and 25-Bb for the blue light having a shorter wavelength than the green light before being output from the light output port 22o. Also, the red light passes through the high-order mode removal portion 25-R for the red light and the high-order mode removal portion 25-B for the blue light having a shorter wavelength than the red light before being output from the light output port 22o.

Thus, in the configuration example shown in FIG. 8C, a configuration is adopted in which the blue light passes through only the high-order mode removal portion for the blue light and the red light and the green light pass through the high-order mode removal portion for the visible light and a high-order mode removal portion for visible light having a shorter wavelength than the visible light.

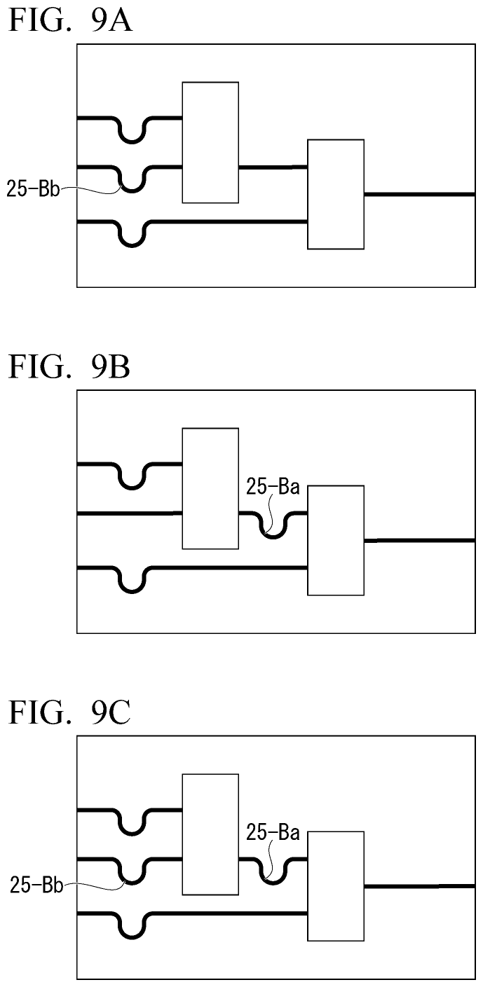

FIGS. 9A to 9C are examples of configurations in which only the arrangement of the high-order mode removal portions is different from those of the optical coupler 102 shown in FIG. 7 and the configurations of FIGS. 8A to 8C. Only the different parts are shown in a simplified manner. FIGS. 9A to 9C are identical to each other in that the high-order mode removal portion for the green light is arranged in the optical waveguide 21-G. In FIGS. 9A to 9C, reference signs of components identical to those of FIG. 7 are omitted. Also, when the arrangement of the high-order mode removal portions in FIGS. 9A to 9C is the same as that in FIGS. 8A to 8C, the high-order mode removal portions are denoted by the same reference signs as those in FIGS. 8A to 8C.

The configuration shown in FIG. 9A is identical to the configuration of the optical coupler 102 shown in FIG. 7, except that the high-order mode removal portion for the blue light is not arranged in the optical waveguide 22 and is arranged in the optical waveguide 21-B.

The configuration shown in FIG. 9B is identical to the configuration of the optical coupler 102 shown in FIG. 7, except that the high-order mode removal portion for the blue light is not arranged in the optical waveguide 22 and is arranged in the optical waveguide 23.

The configuration shown in FIG. 9C is identical to the configuration of the optical coupler 102 shown in FIG. 7, except that the high-order mode removal portion for the blue light is not arranged in the optical waveguide 22 and is arranged in the optical waveguide 21-B and the optical waveguide 23.

In the configuration shown in FIG. 9A, the blue light input from the second light input port 21-Bi propagates through the optical waveguide 21-B, passes through the high-order mode removal portion 25-Bb for the blue light, and is input to the first multimode-interference-type optical coupling portion 50A. Subsequently, after the blue light is coupled with the green light and further coupled with the red light in the second multimode-interference-type optical coupling portion 50B, the coupled light is output from the light output port 22o. The green light input from the second light input port 21-Gi propagates through the optical waveguide 21-G, passes through the high-order mode removal portion 25-G for the green light, and is subsequently input to the first multimode-interference-type optical coupling portion 50A. Subsequently, after the green light is coupled with the blue light and further coupled with the red light in the second multimode-interference-type optical coupling portion 50B, the coupled light is output from the light output port 22o. The red light input from the first light input port 21-Ri propagates through the optical waveguide 21-R and passes through the high-order mode removal portion 25-R for the red light. Subsequently, the red light is coupled with coupled light obtained by coupling the green light and the blue light in the second multimode-interference-type optical coupling portion 50B and the coupled light is subsequently output from the light output port 22o.

As described above, the blue light of the shortest wavelength passes through only the high-order mode removal portion 25-Bb for the blue light before being output from the light output port 22o. Also, the green light passes through only the high-order mode removal portion 25-G for the green light before being output from the light output port 22o. Also, the red light passes through only the high-order mode removal portion 25-R for the red light before being output from the light output port 22o.

Thus, in the configuration example shown in FIG. 9A, a configuration is adopted in which the blue light passes through only the high-order mode removal portion for the blue light, the red light passes only the high-order mode removal portion for the red light, and the green light passes through only the high-order mode removal portion for the green light.

In the configuration shown in FIG. 9B, the blue light input from the second light input port 21-Bi propagates through the optical waveguide 21-B and is input to the first multimode-interference-type optical coupling portion 50A. The blue light is coupled with the green light in the first multimode-interference-type optical coupling portion 50A and then coupled light passes through the high-order mode removal portion 25-Ba for the blue light arranged in the optical waveguide 23 and is further coupled with the red light in the second multimode-interference-type optical coupling portion 50B and output from the light output port 22o. The green light input from the second light input port 21-Gi propagates through the optical waveguide 21-G, passes through the high-order mode removal portion 25-G for the green light, and is subsequently input to the first multimode-interference-type optical coupling portion 50A and coupled with blue light. Subsequently, the green light coupled with the blue light passes through the high-order mode removal portion 25-Ba for the blue light arranged in the optical waveguide 23 and is subsequently coupled with the red light in the second multimode-interference-type optical coupling portion 50B and the coupled light is output from the light output port 22o. The red light input from the first light input port 21-Ri propagates through the optical waveguide 21-R, passes through the high-order mode removal portion 25-R for the red light, and is subsequently coupled with coupled light obtained by coupling the green light and the blue light in the second multimode-interference-type optical coupling portion 50B and the coupled light is output from the light output port 22o.

As described above, the blue light of the shortest wavelength passes through only the high-order mode removal portion 25-Ba for the blue light before being output from the light output port 22o. Also, the green light passes through the high-order mode removal portion 25-G for the green light and the high-order mode removal portion 25-Ba for the blue light having a shorter wavelength than the green light before being output from the light output port 22o. Also, the red light passes through only the high-order mode removal portion 25-R for the red light before being output from the light output port 22o.

Thus, in the configuration example shown in FIG. 9B, a configuration is adopted in which the blue light passes through only the high-order mode removal portion for the blue light, the green light passes through only the high-order mode removal portion for the green light and the high-order mode removal portion for the blue light having a shorter wavelength than the green light, and the red light passes through only the high-order mode removal portion for the red light.

In the configuration shown in FIG. 9C, the blue light input from the second light input port 21-Bi propagates through the optical waveguide 21-3, passes through the high-order mode removal portion 25-Bb for the blue light, and is input to the first multimode-interference-type optical coupling portion 50A. Subsequently, the blue light is coupled with the green light in the first multimode-interference-type optical coupling portion 50A and then coupled light passes through the high-order mode removal portion 25-Ba for the blue light arranged in the optical waveguide 23 and the coupled light is coupled with the red light in the second multimode-interference-type optical coupling portion 50B and output from the light output port 22o. The green light input from the second light input port 21-Gi propagates through the optical waveguide 21-G, passes through the high-order mode removal portion 25-G for the green light, and is subsequently input to the first multimode-interference-type optical coupling portion 50A and coupled with blue light. Subsequently, the green light coupled with the blue light passes through the high-order mode removal portion 25-Ba for the blue light arranged in the optical waveguide 23 and is subsequently further coupled with the red light in the second multimode-interference-type optical coupling portion 50B and the coupled light is output from the light output port 22o. The red light input from the first light input port 21-Ri propagates through the optical waveguide 21-R, passes through the high-order mode removal portion 25-R for the red light, and is subsequently coupled with coupled light obtained by coupling the green light and the blue light in the second multimode-interference-type optical coupling portion 50B and the coupled light is subsequently output from the light output port 22o.

As described above, the blue light of the shortest wavelength passes through only the high-order mode removal portions 25-Ba and 25-Bb for the blue light before being output from the light output port 22o. Also, the green light passes through the high-order mode removal portion 25-G for the green light and the high-order mode removal portion 25-Ba for the blue light having a shorter wavelength than the green light before being output from the light output port 22o. Also, the red light passes through only the high-order mode removal portion 25-R for the red light before being output from the light output port 22o.

Thus, in the configuration example shown in FIG. 9C, a configuration is adopted in which the blue light passes through only the high-order mode removal portion for the blue light, the red light passes through only the high-order mode removal portion for the red light, and the green light passes through only the high-order mode removal portion for the green light and the high-order mode removal portion for the blue light having a shorter wavelength than the green light.

Next, a case where three different wavelengths of visible light are coupled with an optical coupler of a one-stage configuration will be described.

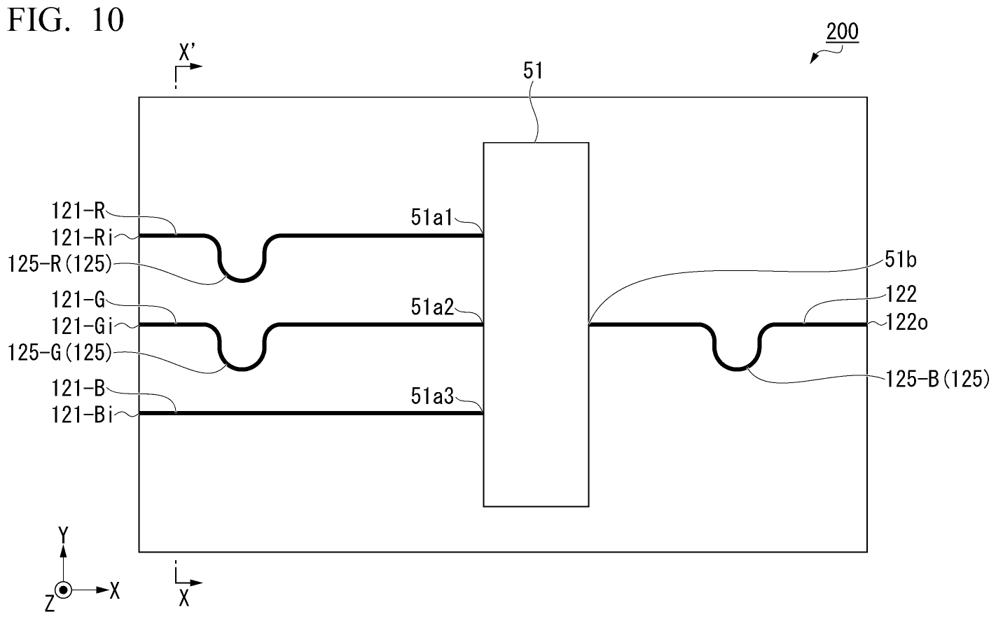

FIG. 10 shows a schematic plan view of the first arrangement pattern of the optical coupler of the one-stage configuration.

In the optical coupler 200 shown in FIG. 10, the optical coupling portion 51 includes an optical coupling portion having a one-stage configuration, the optical waveguide 121-R for the red light, the optical waveguide 121-G for the green light, and the optical waveguide 121-B for the blue light are connected to the light input sides 51a1, 51a2, and 51a3 of the optical coupling portion 51, respectively, and the optical waveguide 122 connected to the light output side 51b of the optical coupling portion 51 is connected to the light output port 122o. The optical coupling portion 51 is the optical coupling portion having the one-stage configuration having three inputs and one output.

In the optical coupler 200 shown in FIG. 10, a high-order mode removal portion 125-B (125) for the blue light is arranged in the optical waveguide 122 for connecting the light output side 51b of the optical coupling portion 51 and the light output port 122o, a high-order mode removal portion 125-R (125) for the red light is arranged in the optical waveguide 121-R for connecting the first light input port 121-Ri and the light input side 51al of the optical coupling portion 51, and a high-order mode removal portion 125-G (125) for the green light is arranged in the optical waveguide 121-G for connecting the second light input port 121-Gi and the light input side 51a2 of the optical coupling portion 51.

The blue light input from the third light input port 121-Bi propagates through the optical waveguide 121-B and is input to the optical coupling portion 51. The blue light input to the optical coupling portion 51 is coupled with the red light and the green light in the optical coupling portion 51. The blue light coupled with the red light and the green light is output from the light output side 51b of the optical coupling portion 51, passes through the high-order mode removal portion 125-B for the blue light arranged in the optical waveguide 122, and is output from the light output port 122o.

The red light input from the first light input port 121-Ri propagates through the optical waveguide 121-R, passes through the high-order mode removal portion 125-R for the red light, and is subsequently input to the optical coupling portion 51. The red light input to the optical coupling portion 51 is coupled with the blue light and the green light in the optical coupling portion 51. The red light coupled with the blue light and the green light is output from the light output side 51b of the optical coupling portion 51, passes through the high-order mode removal portion 125-B for the blue light arranged in the optical waveguide 122, and is output from the light output port 122o.

The green light input from the second light input port 121-Gi propagates through the optical waveguide 121-G, passes through the high-order mode removal portion 125-G for the green light, and is subsequently input to the optical coupling portion 51. The green light input to the optical coupling portion 51 is coupled with the red light and the blue light in the optical coupling portion 51. The green light coupled with the red light and the blue light is output from the light output side 51b of the optical coupling portion 51, passes through the high-order mode removal portion 125-B for the blue light arranged in the optical waveguide 122, and is output from the light output port 122o.

As described above, the blue light of the shortest wavelength passes through only the high-order mode removal portion 125-B for the blue light before being output from the light output port 122o. On the other hand, the red light passes through the high-order mode removal portion 125-R for the red light and the high-order mode removal portion 125-B for the blue light having a shorter wavelength than the red light before being output from the light output port 122o. Also, the green light passes through the high-order mode removal portion 125-G for the green light and the high-order mode removal portion 125-B for the blue light having a shorter wavelength than the green light before being output from the light output port 122o.

Thus, in the configuration example shown in FIG. 10, a configuration is adopted in which the blue light passes through only the high-order mode removal portion for the blue light, the red light passes through the high-order mode removal portion for the red light and the high-order mode removal portion for the blue light having a shorter wavelength than the red light, and the green light passes through the high-order mode removal portion for the green light and the high-order mode removal portion for the blue light having a shorter wavelength than the green light.

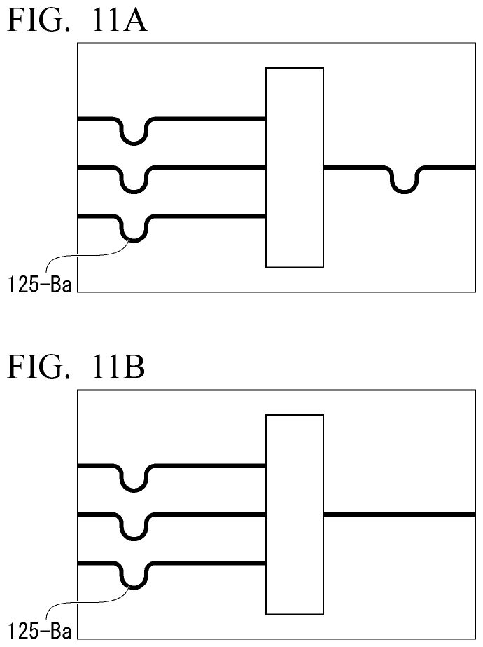

FIG. 11A shows a schematic plan view of a modified example of the first arrangement pattern of the optical coupler of the one-stage configuration.

The configuration shown in FIG. 11A is an example of a configuration in which only the arrangement of the high-order mode removal portions is different from that of the optical coupler 200 shown in FIG. 10. Only the different parts are shown in a simplified manner. The configuration shown in FIG. 11A is identical to that of the optical coupler 200 shown in FIG. 10 in that a high-order mode removal portion 125-B for the blue light arranged in the optical waveguide 122 is provided. On the other hand, the configuration shown in FIG. 11A is different from the optical coupler 200 shown in FIG. 10 in that a high-order mode removal portion 125-Ba arranged in the optical waveguide 121-B is further provided as the high-order mode removal portion for the blue light. In the configuration example shown in FIG. 11A, two high-order mode removal portions for the blue light are provided.

FIG. 11B shows a schematic plan view of the second arrangement pattern of the optical coupler of the one-stage configuration. The configuration shown in FIG. 11B is an example of a configuration in which only the arrangement of the high-order mode removal portions is different from that of the optical coupler 200 shown in FIG. 10. Only the different parts are shown in a simplified manner. The configuration shown in FIG. 11B is identical to the optical coupler 200 shown in FIG. 10 in that one high-order mode removal portion for the blue light is provided. On the other hand, the configuration shown in FIG. 11B is different from that of the optical coupler 200 shown in FIG. 10 in that a position where the high-order mode removal portion for the blue light is arranged is arranged in the optical waveguide 121-B instead of the optical waveguide 122.

In the configuration shown in FIG. 11A, the blue light input from the third light input port 121-Bi propagates through the optical waveguide 121-B, passes through the high-order mode removal portion 125-Ba for the blue light arranged in the optical waveguide 121-B, and is subsequently input to the optical coupling portion 51. The blue light input to the optical coupling portion 51 is coupled with the red light and the green light in the optical coupling portion 51. The blue light coupled with red light and the green light is output from the light output side 51b of the optical coupling portion 51, passes through the high-order mode removal portion 125-B for the blue light arranged in the optical waveguide 122, and is output from the light output port 122o.

The red light input from the first light input port 121-Ri propagates through the optical waveguide 121-R, passes through the high-order mode removal portion 125-R for the red light, and is subsequently input to the optical coupling portion 51. The red light input to the optical coupling portion 51 is coupled with the blue light and the green light in the optical coupling portion 51. The red light coupled with the blue light and the green light is output from the light output side 51b of the optical coupling portion 51, passes through the high-order mode removal portion 125-B for the blue light arranged in the optical waveguide 122, and is output from the light output port 122o.

The green light input from the second light input port 121-Gi propagates through the optical waveguide 121-G, passes through the high-order mode removal portion 125-G for the green light, and is subsequently input to the optical coupling portion 51. The green light input to the optical coupling portion 51 is coupled with the red light and the blue light in the optical coupling portion 51. The green light coupled with the red light and the blue light is output from the light output side 51b of the optical coupling portion 51, passes through the high-order mode removal portion 125-B for the blue light arranged in the optical waveguide 122, and is output from the light output port 122o.

As described above, the blue light of the shortest wavelength passes through only the high-order mode removal portions 125-B and 125-Ba for the blue light before being output from the light output port 122o. On the other hand, the red light passes through the high-order mode removal portion 125-R for the red light and the high-order mode removal portion 125-B for the blue light having a shorter wavelength than the red light before being output from the light output port 122o. Also, the green light passes through the high-order mode removal portion 125-G for the green light and the high-order mode removal portion 125-B for the blue light having a shorter wavelength than the green light before being output from the light output port 122o.

Thus, in the configuration example shown in FIG. 11A, a configuration is adopted in which the blue light passes through only the high-order mode removal portion for the blue light, the red light passes through the high-order mode removal portion for the red light and the high-order mode removal portion for the blue light having a shorter wavelength than the red light, and the green light passes through the high-order mode removal portion for the green light and the high-order mode removal portion for the blue light having a shorter wavelength than the green light.

In the configuration shown in FIG. 11B, the blue light input from the third light input port 121-Bi propagates through the optical waveguide 121-B and is input to the optical coupling portion 51. The blue light input to the optical coupling portion 51 is coupled with the red light and the green light in the optical coupling portion 51. The blue light coupled with the red light and the green light is output from the light output side 51b of the optical coupling portion 51 and output from the light output port 122o.

The red light input from the first light input port 121-Ri propagates through the optical waveguide 121-R, passes through the high-order mode removal portion 125-R for the red light, and is subsequently input to the optical coupling portion 51. The red light input to the optical coupling portion 51 is coupled with the blue light and the green light in the optical coupling portion 51. The red light coupled with the blue light and the green light is output from the light output side 51b of the optical coupling portion 51 and output from the light output port 122o.

The green light input from the second light input port 121-Gi propagates through the optical waveguide 121-G, passes through the high-order mode removal portion 125-G for the green light, and is subsequently input to the optical coupling portion 51. The green light input to the optical coupling portion 51 is coupled with the red light and the blue light in the optical coupling portion 51. The green light coupled with the red light and the blue light is output from the light output side 51b of the optical coupling portion 51 and output from the light output port 122o.

As described above, the blue light of the shortest wavelength passes through only the high-order mode removal portion 125-Ba for the blue light before being output from the light output port 122o. On the other hand, the red light passes through only the high-order mode removal portion 125-R for the red light before being output from the light output port 122o. Also, the green light passes through only the high-order mode removal portion 125-G for the green light before being output from the light output port 122o.

Thus, in the configuration example shown in FIG. 11B, a configuration is adopted in which the blue light passes through only the high-order mode removal portion for the blue light, the red light passes through only the high-order mode removal portion for the red light, and the green light passes through only the high-order mode removal portion for the green light.

### <Configuration of Bending Waveguide>

In FIGS. 1 to 11, an example in which the high-order mode removal portion is a bending waveguide is shown.

Hereinafter, a configuration of the bending waveguide for use in the high-order mode removal portion in the optical coupler according to the present embodiment will be described.

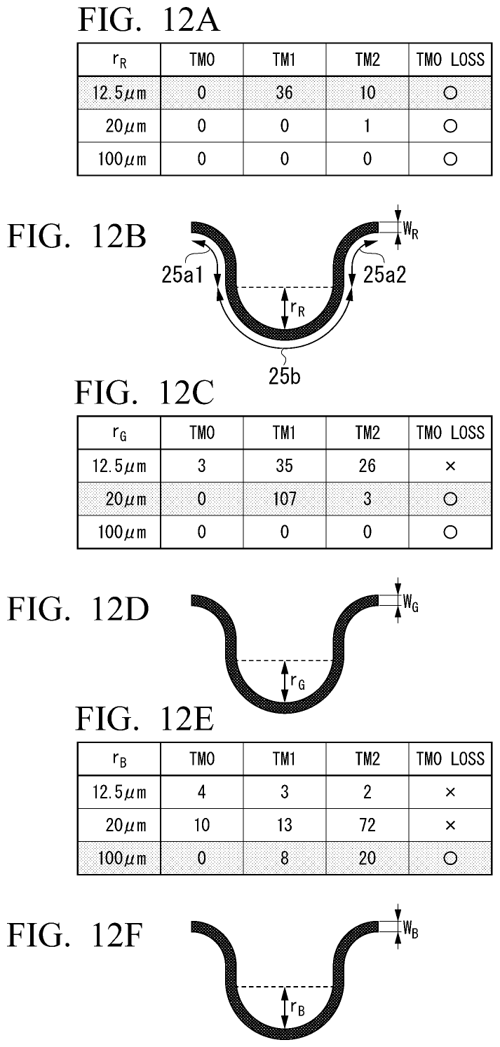

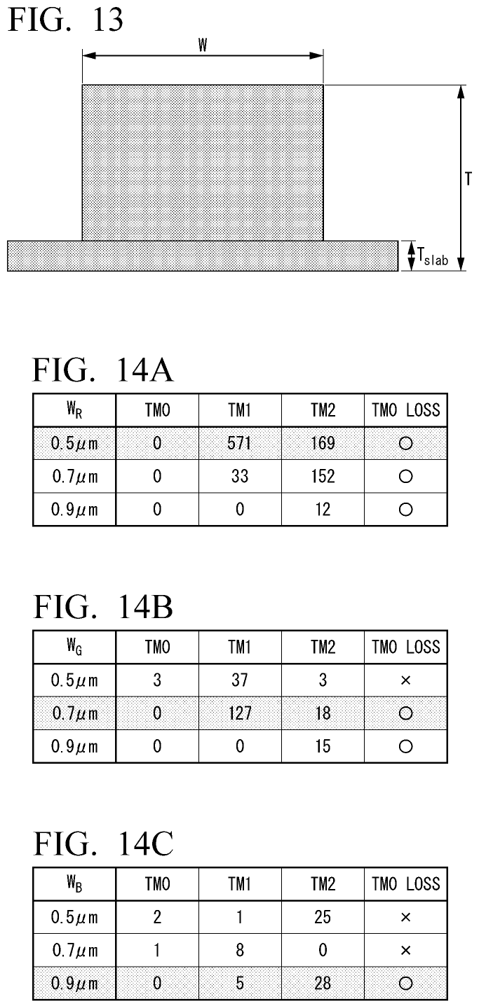

FIGS. 12A to 12F show results of studying relationships between a radius of the circumferential shape portion constituting the bending waveguide and propagation losses (dB) of the basic mode light (TM0) and two low-order light beams (TM1 and TM2) of the high-order mode light for each visible light beam in simulation as Example 1. The planar shape of the model of the bending waveguide used in the simulation is as shown in FIGS. 12A to 12F and the cross-sectional shape is shown in FIG. 13.

As shown in FIGS. 12A to 12F, the planar shape of the bending waveguide includes a circumferential shape portion (semicircle) 25b having a radius r and connection portions 25a1 and 25a2 connected to both ends of the circumferential shape portion 25b, respectively. The connection portions 25al and 25a2 each have a shape of a circle of ¼ of the radius r. In FIGS. 12A to 12F, radii r of bending waveguides for RGB visible light beams are denoted by r_{R}, r_{G}, and r_{B}. Also, line widths W of the bending waveguides for the RGB visible light beams are denoted by W_{R}, W_{G}, and W_{B}, respectively.

In FIG. 13 showing the cross-sectional shape of the bending waveguide, a dimension denoted by reference sign W is the line width of the bending waveguide, a dimension denoted by reference sign T_{slab} is the thickness of the slab portion, and a dimension denoted by reference sign T is the thickness of the entire bending waveguide including the thickness of the slab portion.

Fimmwave (Photon Design) was used as the simulation software.

The values of parameters are as follows.
The bending waveguide for the red light is as follows;
   Line width W_{R} of waveguide: 0.9 μm,
   Thickness T of waveguide: 0.7 μm,
   Thickness T_{slab} of slab portion: 0.15 μm,
   Radius r_{R} of circumferential shape portion: 12.5 μm, 20 μm, or 100 μm, and
   Wavelength: 638 nm.
The bending waveguide for the green light is as follows;
   Line width WG of waveguide: 0.9 μm,
   Thickness T of waveguide: 0.7 μm,
   Thickness T_{slab} of slab portion: 0.15 μm,
   Radius r_{G} of circumferential shape portion: 12.5 μm, 20 μm, or 100 μm, and
   Wavelength: 520 nm.
The bending waveguide for the blue light is as follows;
   Line width WB of waveguide: 0.9 μm,
   Thickness T of waveguide: 0.7 μm,
   Thickness T_{slab} of slab portion: 0.15 μm,
   Radius r_{B} of circumferential shape portion: 12.5 μm, 20 μm, or 100 μm, and
   Wavelength: 455 nm.

When the dimensions of the waveguide other than the radius of the circumferential shape portion are set as described above, the following knowledge was obtained about the radius of the circumferential shape portion of each bending waveguide for visible light.

The propagation losses (dB) of the basic mode TM0, and the high-order modes TM1 and TM2 of the bending waveguide for the red light were as shown in FIGS. 12A to 12F. When the radius IR of the circumferential shape portion was 12.5 μm, there was no loss of the basic mode TM0, and the loss of the high-order modes TM1 and TM2 could be reduced (the high-order modes TM1 and TM2 could be removed). On the other hand, when the radius IR of the circumferential shape portion was 20 μm and 100 μm, there was no loss of the basic mode TM0, but the loss of high-order modes TM1 and TM2 could not be reduced or could not be substantially reduced. Therefore, it was found that 12.5 μm was suitable among the radii IR of the three simulated circumferential shape portions.

Also, in the propagation losses (dB) of the basic mode TM0, and the high-order modes TM1 and TM2 of the bending waveguide for the green light, when the radius IG of the circumferential shape portion was 20 μm, there was no loss of the basic mode TM0 and the loss of the high-order modes TM1 and TM2 could be reduced. On the other hand, there was a loss of the basic mode TM0 when the radius r_{G} of the circumferential shape portion is 12.5 μm, and there was no loss of the basic mode TM0, but the loss of the high-order modes TM1 and TM2 could not be reduced when the radius r_{G} of the circumferential shape portion was 100 μm. Therefore, it was found that 20 μm was suitable among the radii r_{G} of the three simulated circumferential shape portions.

Also, in the propagation losses (dB) of the basic mode TM0, and the high-order modes TM1 and TM2 of the bending waveguide for the blue light, when the radius r_{B} of the circumferential shape portion was 100 μm, there was no loss in the basic mode TM0 and the high-order modes TM1 and TM2 could be reduced. On the other hand, when the radius r_{B} of the circumferential shape portion was 12.5 μm and 20 μm, there was a loss of the basic mode TM0. Therefore, it was found that 100 μm was suitable among the radii r_{B} of the three simulated circumferential shape portions.

FIGS. 14A to 14C show results of studying relationships between a width of the bending waveguide and propagation losses (dB) of the basic mode light (TM0) and low-order light beams (TM1 and TM2) of the high-order mode light for each visible light beam in simulation as Example 2.

When the radius r of the circumferential shape portion of each bending waveguide for visible light was 200 μm and the other dimensions were as described above, the following knowledge was obtained about the width of each bending waveguide for visible light.

The propagation losses (dB) of the basic mode TM0, and the high-order modes TM1 and TM2 of the bending waveguide for the red light were as shown in FIG. 14A. When the width WR of the bending waveguide was 0.5 μm, there was no loss of the basic mode TM0 and the losses of the high-order modes TM1 and TM2 could be reduced. Even if the width WR of the bending waveguide was 0.7 μm, there was no loss of the basic mode TM0 and the losses of the high-order modes TM1 and TM2 could be reduced. Here, the loss reduction of the high-order modes TM1 and TM2 when the width WR of the bending waveguide was 0.5 μm was greater than that when the width WR of the bending waveguide was 0.7 μm. When the width WR of the bending waveguide was 0.9 μm, there was no loss of the basic mode TM0, but the loss of the first-order mode TM1 could not be reduced and the loss of TM2 was also not significantly reduced compared to the case where the width WR of the bending waveguide was 0.5 μm and 0.7 μm. Therefore, 0.5 μm was found to be most suitable among widths W_{R} of the three types of bending waveguides for which simulation was performed, and 0.7 μm was the second most suitable.

Also, in the propagation losses (dB) of the basic mode TM0, the high-order modes TM1 and TM2 of the bending waveguide for the green light, there was a loss of the basic mode TM0 when the width WG of the bending waveguide was 0.5 μm. On the other hand, when the width WG of the bending waveguide was 0.7 μm, there was no loss of the basic mode TM0 and the losses of the high-order modes TM1 and TM2 could be reduced. When the width WG of the bending waveguide was 0.9 μm, there was no loss of the basic mode TM0 but the loss of the high-order mode TM1 could not be reduced. Therefore, 0.7 μm was found to be most suitable among widths WG of the three types of bending waveguides for which simulation was performed.

Also, in the propagation losses (dB) of the basic mode TM0 and the high-order modes TM1 and TM2 of the bending waveguide for the blue light, when the width WB of the bending waveguide was 0.9 μm, there was no loss of the basic mode TM0 and the losses of the high-order modes TM1 and TM2 could be reduced. On the other hand, when the width WB of the bending waveguide was 0.5 μm and 0.7 μm, there was a loss of the basic mode TM0. Therefore, 0.9 μm was found to be most suitable among widths WB of the three types of bending waveguides for which simulation was performed.

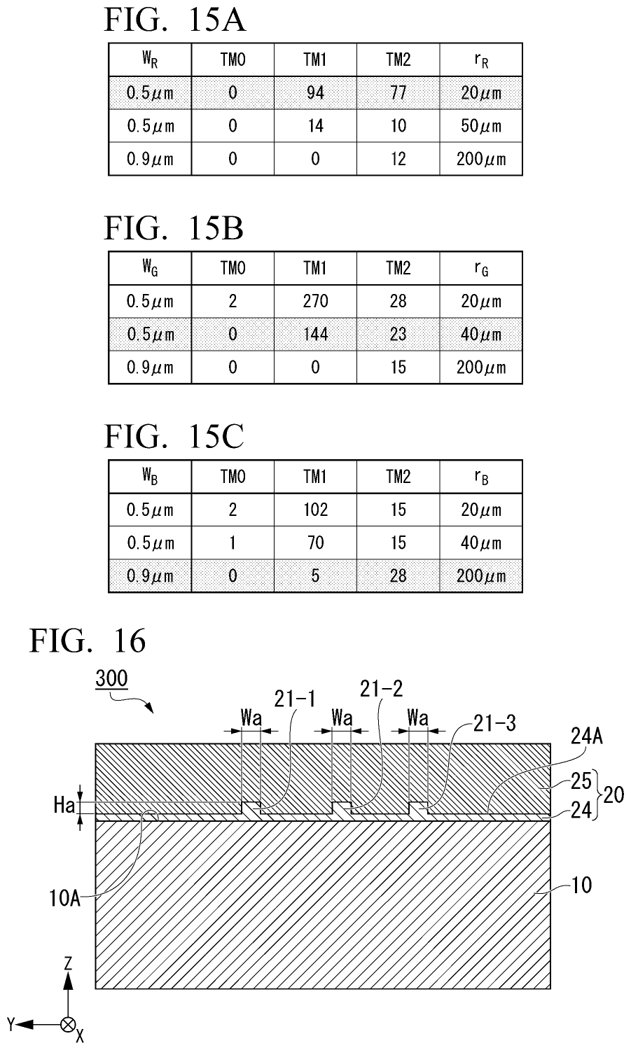

FIGS. 15A to 15C show results of studying relationships between a width of the bending waveguide, a radius of the circumferential shape portion, and propagation losses (dB) of the basic mode light (TM0) and low-order light beams (TM1 and TM2) of the high-order mode light for each visible light beam in simulation as Example 3.

When the width of each bending waveguide for visible light and the radius of the circumferential shape portion thereof are the following combinations and the other dimensions are as described above, the following knowledge was obtained about the width of each bending waveguide for visible light and the radius of the circumferential shape portion thereof.

The propagation losses (dB) of the basic mode TM0, the high-order modes TM1 and TM2 of the bending waveguide for the red light are as shown in FIG. 15A. When the width W_{R} of the bending waveguide was 0.5 μm and the radius IR of the circumferential shape portion was 20 μm, there was no loss of the basic mode TM0 and the losses of the high-order modes TM1 and TM2 could be sufficiently reduced. When the width W_{R} of the bending waveguide was 0.7 μm and the radius IR of the circumferential shape portion was 50 μm, there was no loss of the basic mode TM0 and the losses of the high-order modes TM1 and TM2 could be reduced to some extent. When the width W_{R} of the bending waveguide was 0.9 μm and the radius r_{R} of the circumferential shape portion was 200 μm, there was no loss of the basic mode TM0, but the loss of the first-order mode TM1 could not be reduced, and the loss of TM2 was also not significantly reduced. Therefore, a combination in which the width W_{R} of the bending waveguide was 0.5 μm and the radius IR of the circumferential shape portion was 20 μm among three types of combinations for which simulation was performed was found to be most suitable.

Also, in the propagation losses (dB) of the basic mode TM0, the high-order modes TM1 and TM2 of the bending waveguide for the green light, there was a loss of the basic mode TM0 when the width WG of the bending waveguide was 0.5 μm and the radius r_{G} of the circumferential shape portion was 20 μm. On the other hand, when the width WG of the bending waveguide was 0.7 μm and the radius r_{G} of the circumferential shape portion was 40 μm, there was no loss of the basic mode TM0 and the losses of the high-order modes TM1 and TM2 could be sufficiently reduced. When the width WG of the bending waveguide was 0.9 μm and the radius IR of the circumferential shape portion was 200 μm, there was no loss of the basic mode TM0, but the loss of the first-order mode TM1 could not be reduced, and the loss of TM2 was also not significantly reduced. Therefore, a combination in which the width WG of the bending waveguide was 0.5 μm and the radius IG of the circumferential shape portion was 40 μm among the three types of combinations for which simulation was performed was found to be most suitable.

Also, in the propagation losses (dB) of the basic mode TM0, and the high-order modes TM1 and TM2 of the bending waveguide for the blue light, when the width WB of the bending waveguide was 0.5 μm and the radius r_{B} of the circumferential shape portion was 20 μm, there was a loss of the basic mode TM0. Also, when the width WB of the bending waveguide was 0.7 μm and the radius r_{B} of the circumferential shape portion was 40 μm, there was a loss of the basic mode TM0. On the other hand, when the width WB of the bending waveguide was 0.9 μm and the radius r_{B} of the circumferential shape portion was 200 μm, there is no loss of the basic mode TM0 and the loss of the high-order mode TM1 could be reduced to some extent, and the loss of the high-order mode TM2 could be significantly reduced. Therefore, a combination in which the width WB of the bending waveguide was 0.9 μm and the radius r_{B} of the circumferential shape portion was 200 μm among the three types of combinations for which simulation was performed was found to be most suitable.

### [Optical Coupling Member]

The optical coupling member according to the embodiment of the present invention includes a substrate made of a material different from lithium niobate and an optical coupling function layer made of a lithium niobate film formed on a main surface of the substrate. The optical coupler according to the embodiment of the present invention is formed in the optical coupling function layer.

FIG. 16 is a cross-sectional schematic view of the optical coupling member 300 in which the optical coupler 100 shown in FIG. 1 is formed on an optical coupling function layer made of lithium niobate cut along the YZ plane (X-X′ in FIG. 1) as an example. Regarding the above-described components, components having functions similar to those of the above-described embodiment are denoted by the same reference signs and description thereof may be omitted.

The optical coupling member 300 shown in FIG. 16 includes a substrate 10 made of a material different from lithium niobate, and an optical coupling function layer 20 formed on a main surface of the substrate 10 and made of lithium niobate. The optical coupler 100 is formed in the optical coupling function layer 20.

In the optical coupling member 300, when a refractive index difference between a waveguide core film and a waveguide cladding film is Δn, if the waveguide core film is made of lithium niobate, An can be designed to a value larger than that of a material such as glass and the radius of curvature of the optical waveguide can be reduced. Further, it is possible to achieve both improved design freedom and miniaturization by using a multimode-interference-type optical coupling portion and preventing a coupling length from increasing as compared with a case where a directional coupler is used.

The optical coupling function layer 20 includes: a waveguide core film 24 made of a lithium niobate film in which the above-described light input port, the above-described light output port, the above-described optical coupling portion, and the optical waveguide are formed; and a waveguide cladding (buffer) film 25 formed on the waveguide core film 24 to cover these. Hereinafter, reference sign 24 may denote the lithium niobate film.

Examples of the substrate 10 include a sapphire substrate, a Si substrate, a thermal silicon oxide substrate, and the like.

Because the optical coupling function layer 20 is made of a lithium niobate (LiNbO₃) film, it is not particularly limited as long as it has a lower refractive index than the lithium niobate film. As the substrate on which a single-crystal lithium niobate film can be formed as an epitaxial film, a single-crystal sapphire substrate or a single-crystal silicon substrate is preferable. The crystal orientation of the single-crystal substrate is not particularly limited. For example, because a c-axis oriented lithium niobate film has three-fold symmetry, the underlying single-crystal substrate also desirably has the same symmetry. In the case of a single-crystal sapphire substrate, a c-plane substrate is preferable. In the case of a single-crystal silicon substrate, a (111) plane substrate is preferable.

The lithium niobate film is, for example, a c-axis oriented lithium niobate film. The lithium niobate film is, for example, an epitaxial film epitaxially grown on the substrate 10. The epitaxial film is a single-crystal film in which the crystal orientation is aligned by the underlying substrate. The epitaxial film is a film having a single crystal orientation in a Z-direction and an XY plane direction, and the crystals are aligned and oriented in an X-axis, a Y-axis, and a Z-axis. Whether or not the film formed on the substrate 10 is an epitaxial film can be proved, for example, by confirming the peak intensity and the pole at the orientation position in 2θ-θ X-ray diffraction.

Specifically, when measurement based on 2θ-θ X-ray diffraction is performed, all peak intensities other than that of the target plane are 10% or less, preferably 5% or less of the maximum peak intensity of the target plane. For example, when the lithium niobate film is a c-axis oriented epitaxial film, the peak intensity other than the (00L) plane is 10% or less, preferably 5% or less of the maximum peak intensity of the (00L) plane. Here, (00L) is a general term for equivalent planes such as (001) and (002).

Also, in the conditions for confirming the peak intensity at the above-described orientation position, only orientation in one direction is shown. Therefore, even if the above-described conditions are obtained, when the crystal orientation is not aligned in the plane, the intensity of the X-rays does not increase at a specific angle position, and the pole is not observed. For example, because LiNbO₃ has a trigonal crystal structure in the case of the lithium niobate film, there are three poles of LiNbO₃ (014) in a single crystal.

In the case of lithium niobate, it is known that epitaxial growth occurs in a so-called twin crystal state in which crystals rotated 180° around the c-axis are symmetrically bonded. In this case, because the three poles are symmetrically bonded by two, the number of poles is six. Also, when a lithium niobate film is formed on a single-crystal silicon substrate on the (100) plane, because the substrate has four-fold symmetry, 4×3=12 poles are observed. Also, in the present disclosure, a lithium niobate film epitaxially grown in a twin-crystal state is also included in the epitaxial film.

The composition of lithium niobate is LiₓNbA_{y}O_{z}. A denotes an element other than Li, Nb, and O. x is 0.5 or more and 1.2 or less, preferably 0.9 or more and 1.05 or less. y is 0 or more and 0.5 or less. z is 1.5 or more and 4.0 or less, preferably 2.5 or more and 3.5 or less. The elements A are, for example, K, Na, Rb, Cs, Be, Mg, Ca, Sr, Ba, Ti, Zr, Hf, V, Cr, Mo, W, Fe, Co, Ni, Zn, Sc, and Ce, and two or more of these elements may be included.

Furthermore, the lithium niobate film may be a single-crystal thin lithium niobate film bonded on the substrate.

A film thickness of the lithium niobate film is, for example, 2 μm or less. The film thickness of the lithium niobate film is a film thickness of a portion other than a ridge. The film thickness of the lithium niobate film may be appropriately designed in accordance with a wavelength to be used, a ridge shape, and the like.

The waveguide is a ridge protruding from a first surface 24A of a lithium niobate film 24. The first surface 24A is an upper surface in a portion (slab layer) other than the ridge of the lithium niobate film 24.

Although the cross-sectional shape of the cross-sectional shape portion of each of the optical waveguide 21-1, the optical waveguide 21-2, and the optical waveguide 21-3 is rectangular as shown in FIG. 16, the shape may be, for example, trapezoidal, triangular, semicircular, or the like, as long as it can guide light. A width Wa of each of the three ridges in the Y-direction is preferably 0.2 μm or more and 5.0 μm or less, and the height of each of the three ridges (a protruding height Ha from the first surface 24A) is, for example, 0.1 μm or more and preferably 1.0 μm or less. The same is true for other optical waveguides.

Light can propagate in a single mode by setting the size of each of the optical waveguide 21-1, the optical waveguide 21-2, the optical waveguide 21-3 and another optical waveguide shown in FIG. 1 to about the wavelength of the laser light.

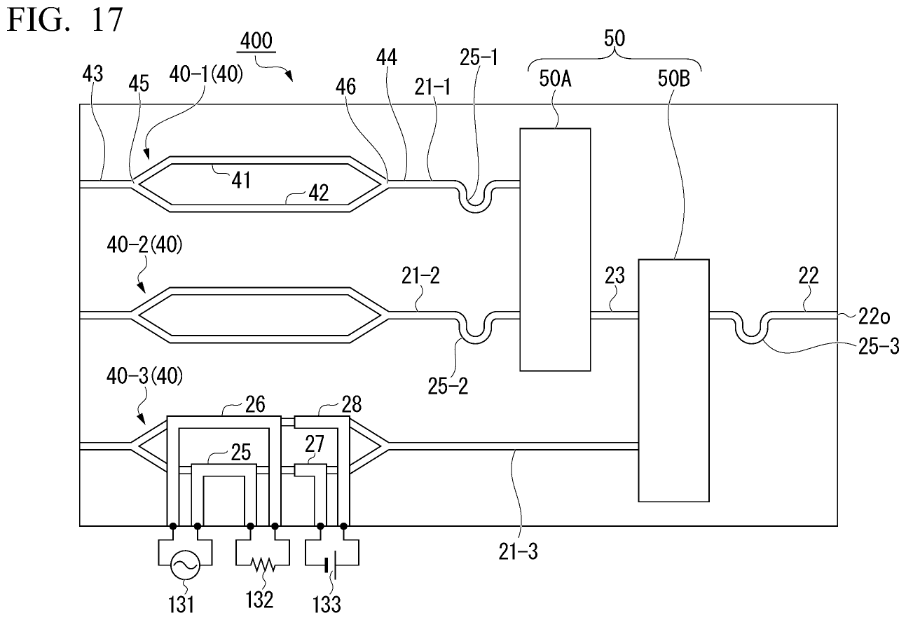

FIG. 17 is a schematic plan view of a modified example of an optical coupling member according to an embodiment of the present invention.

An optical coupling member 400 shown in FIG. 17 includes: a substrate 10 (see FIG. 16) made of a material different from lithium niobate; and an optical coupling function layer 20 made of a lithium niobate film formed on a main surface of the substrate 10. The optical coupling member 400 with an optical modulation function is formed within the optical coupling function layer 20.

The optical coupling member 400 with the optical modulation function includes the optical coupling portion 50 (see FIG. 1) according to the above embodiment and a Mach-Zehnder-type optical waveguide 40.

Although the Mach-Zehnder-type optical waveguide 40 includes three Mach-Zehnder-type optical waveguides 40-1, 40-2, and 40-3, two or four or more Mach-Zehnder-type optical waveguides can be provided according to the number of input ports of the first multimode-interference-type optical coupling portion 50A.

Although the optical coupling member 400 with the optical modulation function is configured using the optical coupling portion 50 of the two-stage configuration as the optical coupler, it may be configured using the optical coupling portion 51 of the one-stage configuration (see FIG. 10) instead of the optical coupling portion 50 of the two-stage configuration or may be configured using an optical coupler of another configuration.

As the Mach-Zehnder-type optical waveguide 40, a known Mach-Zehnder-type optical modulator or an optical waveguide can be used. A light beam having a wavelength and a phase is divided into a pair of two light beams and different phases are given to each other and then the light beams are merged (coupled). Depending on a difference in a phase difference, the intensity of the coupled light beam changes.

Each of the Mach-Zehnder-type optical waveguides 40 (40-1, 40-2, and 40-3) shown in FIG. 17 includes a first optical waveguide 41, a second optical waveguide 42, an input path 43, an output path 44, a branch portion 45, and a coupling portion 46.

The first output path 44 of the Mach-Zehnder-type optical waveguide 40-1 is connected to a first light-input-side optical waveguide 21-1 of the first multimode-interference-type optical coupling portion 50A. Also, the first output path 44 of the Mach-Zehnder-type optical waveguide 40-2 is connected to a second light-input-side optical waveguide 21-2 of the first multimode-interference-type waveguide 50A. Also, the first output path 44 of the Mach-Zehnder-type optical waveguide 40-3 is connected to a third light-input-side optical waveguide 21-3 of the first multimode-interference-type waveguide 50A.

The first optical waveguide 41 and the second optical waveguide 42 shown in FIG. 17 have a configuration extending in a straight line in the X-direction, except for the vicinity of the branch portion 45 and the vicinity of the coupling portion 46, but is not limited to such a configuration. The lengths of the first optical waveguide 41 and the second optical waveguide 42 shown in FIG. 17 are substantially the same. The branch portion 45 is between the input path 43 and either one of the first optical waveguide 41 or the second optical waveguide 42. The input path 43 is connected to the first optical waveguide 41 and the second optical waveguide 42 via the branch portion 45. The coupling portion 46 is between either one of the first optical waveguide 41 or the second optical waveguide 42 and the output path 44. The first optical waveguide 41 and the second optical waveguide 42 are connected to the output path 44 via the coupling portion 46.

The electrodes 25 and 26 are electrodes for applying a modulation voltage to each of the Mach-Zehnder-type optical waveguide 40-1, 40-2, and 40-3 (hereinafter simply referred to as “each Mach-Zehnder-type optical waveguide 40”). The electrode 25 is an example of the first electrode and the electrode 26 is an example of the second electrode. One end of the electrode 25 is connected to a power supply 131 and the other end is connected to a termination resistor 132.

One end of the electrode 26 is connected to the power supply 131 and the other end is connected to the termination resistor 132. The power supply 131 is a part of a drive circuit that applies the modulation voltage to each Mach-Zehnder-type optical waveguide 40. For the sake of simplification of the drawing, the electrodes 25 and 26 are drawn only on the portion of the Mach-Zehnder-type optical waveguide 40-3.

The electrodes 27 and 28 are electrodes that apply a DC bias voltage to each Mach-Zehnder-type optical waveguide 40. One end of the electrode 27 and one end of the electrode 28 are connected to the power supply 133. The power supply 133 is a part of a DC bias application circuit that applies a DC bias voltage to each Mach-Zehnder-type optical waveguide 40.

When the DC bias voltage is superimposed on the electrodes 25 and 26, the electrodes 27 and 28 may not be provided. Also, a ground electrode may be provided around the electrodes 25, 26, 27, and 28.

### Visible Light Source Module (First Embodiment)

A visible light source module according to a first embodiment of the present invention includes the optical coupling member according to the embodiment of the present invention and a plurality of visible laser light sources configured to output visible light that is coupled by the optical coupling member.

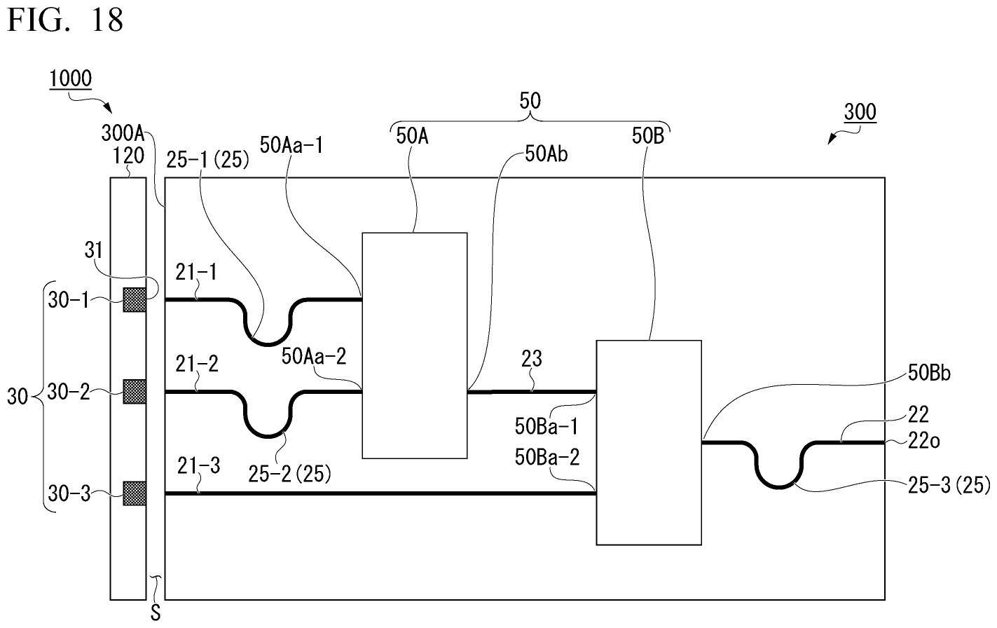

FIG. 18 is a schematic plan view of the visible light source module according to the first embodiment. In FIG. 18, an example of the visible light source module including an optical coupling member 300 shown in FIG. 16 is shown.

The visible light source module 1000 shown in FIG. 18 includes: an optical coupling member 300 having an optical coupling portion 50 of a two-stage configuration in which the first multimode-interference-type optical coupling portion 50A and the second multimode-interference-type optical coupling portion 50B are connected; and three visible laser light sources 30 (30-1, 30-2, and 30-3) configured to output visible light coupled by the optical coupling member 300. The optical coupling member 300 includes: the substrate 10 (see FIG. 16) made of a material different from lithium niobate; and the optical coupling function layer 20 (see FIG. 16) formed on the main surface of the substrate 10 and made of lithium niobate and has a side surface 300A.

Regarding the component shown in FIG. 18, components having functions similar to those of the above-described components are denoted by the same reference signs and description thereof may be omitted.

As the visible laser light source 30, various types of laser elements can be used. For example, commercially available laser diodes (LD) for red light, green light, blue light, and the like can be used. For the red light, light having a peak wavelength of 600 nm or more and 750 nm or less can be used. For the green light, light having a peak wavelength of 500 nm or more and 600 nm or less can be used. For the blue light, light having a peak wavelength of 380 nm or more and 500 nm or less can be used.

In the visible light source module 1000, the visible laser light sources 30-1, 30-2, and 30-3 are assumed to be an LD that emits red light, an LD that emits green light, and an LD that emits blue light, respectively. The LDs 30-1, 30-2, and 30-3 are arranged at intervals in directions substantially orthogonal to directions of light output from the LDs and are provided on the upper surface of the subcarrier 120.

Although examples of cases where the number of visible laser light sources are 2 and 3 in the visible light source module 1000 have been described, the number is not limited to two or three if the number are two or more and may be four or more. The plurality of visible laser light sources may all have different wavelengths of light to be emitted or may be visible laser light sources having the same wavelength of light to be emitted. Also, light other than red (R), green (G), and blue (B) can be used as the light to be emitted and the mounting order of red (R), green (G), and blue (B) described with reference to the drawings is also not necessary to be in that order, and can be appropriately changed.

The LD 30 can be mounted on a subcarrier 120 with a bare chip. The subcarrier 120 is made of, for example, aluminum nitride (AlN), aluminum oxide (Al₂O₃), silicon (Si), or the like.

The subcarrier 120 can have a configuration directly bonded to the substrate 10 via a metallic bonding layer. This configuration enables further miniaturization without performing spatial coupling or fiber coupling.

In the case where a configuration is adopted in which the subcarrier 120 and the substrate 10 are bonded via the metallic bonding layer, it is possible to align the optical axis position of the laser beam (active alignment) so that the optical axis of each visible light laser coincides with the axis of the first light-input-side optical waveguide 21-1, the second light-input-side optical waveguide 21-2, or the third light-input-side optical waveguide 21-3 by adjusting relative positions of the subcarrier 120 and the substrate 10 during manufacturing.

In the visible light source module 1000, the three light-input-side optical waveguides of the first multimode-interference-type optical coupling portion 50A, i.e., the first light-input-side optical waveguides 21-1, the second light-input-side optical waveguides 21-2, and the third light-input-side optical waveguides 21-3, face the output ports of the LDs 30 (30-1, 30-2, and 30-3), and a positioning process is performed so that light output from the output surfaces of the LDs 30 can be input to the first light-input-side optical waveguide 21-1, the second light-input-side optical waveguide 21-2, and the third light-input-side optical waveguide 21-3. The axes of the first light-input-side optical waveguide 21-1, the second light-input-side optical waveguide 21-2, and the third light-input-side optical waveguide 21-3 substantially overlap the axes of laser light output from the output ports of the LDs 30.

With such a configuration and arrangement, the red light, the green light, and the blue light output from the LDs 30-1, 30-2, and 30-3 can be input to the three light-input-side optical waveguides, i.e., the first light-input-side optical waveguide 21-1, the second light-input-side optical waveguides 21-2, and the third light-input-side optical waveguides 21-3, in the first multimode-interference-type optical coupling portion 50A.

In the visible light source module 1000, the light output surface 31 of the LD 30 and the light input surface (side) 300A of the optical coupling member 300 are arranged at predetermined intervals. The light input surface 300A faces the light output surface 31 and there is a gap S between the light output surface 31 and the light input surface 300A in the X-direction. Because the visible light source module 1000 is exposed in the air, the gap S is filled with air. Because the gap S is filled with the same gas (air), it is easy to input colored light output from the LD 30 to the input path in a state in which predetermined coupling efficiency is satisfied. When the visible light source module 1000 is used for AR glasses and VR glasses, the size of the gap (interval) S in the X-direction is, for example, greater than 0 μm and 5 μm or less, based on the amount of light required for the AR glasses and VR glasses and the like.

### Visible Light Source Module (Second Embodiment)

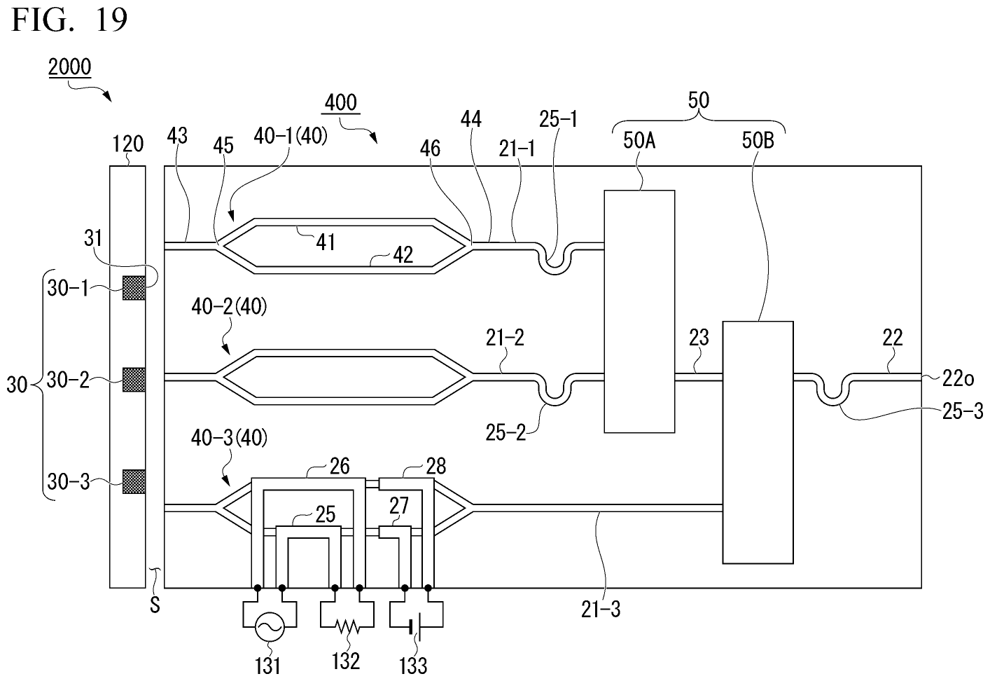

FIG. 19 is a schematic plan view of a visible light source module according to a second embodiment.

A visible light source module 2000 shown in FIG. 19 includes the optical coupling member 400 with the optical modulation function shown in FIG. 17 and a plurality of visible laser light sources 30 (30-1, 30-2, and 30-3) configured to output visible light to be coupled by the optical coupling member 400 with the optical modulation function. The optical coupling member 400 includes the substrate 10 (see FIG. 16) made of a material different from lithium niobate, and the optical coupling function layer 20 (see FIG. 16) formed on the main surface of the substrate 10 and made of lithium niobate, and has a side surface 300A.

Regarding the component shown in FIG. 19, components having functions similar to those of the above-described components are denoted by the same reference signs and description thereof may be omitted.

Although the visible light source module 2000 is configured using the optical coupling portion 50 of the two-stage configuration as the optical coupler, it may be configured using the optical coupling portion 51 of the one-stage configuration (see FIG. 10) instead of the optical coupling portion 50 of the two-stage configuration or may be configured using an optical coupler of another configuration.

The visible light source module 2000 has three Mach-Zehnder-type optical waveguides 40-1, 40-2, and 40-3 equal in number to the visible laser light sources 30-1, 30-2, and 30-3. The visible laser light sources 30-1, 30-2, and 30-3 and the Mach-Zehnder-type optical waveguides 40-1, 40-2, and 40-3 are positioned so that light output from the visible laser light source is input to the corresponding Mach-Zehnder-type optical waveguide.

It is possible to adopt a configuration in which a subcarrier 120 on which the visible laser light sources 30-1, 30-2, and 30-3 are mounted, and a substrate 10 on which an optical coupling function layer 20 having the optical coupling member 400 with an optical modulation function is formed are directly bonded via a metallic bonding layer. This configuration enables further miniaturization without performing spatial coupling or fiber coupling.

Also, it is possible to align the optical axis position of the laser beam (active alignment) so that the optical axis of each visible light laser coincides with the axis of an input path 43 of the Mach-Zehnder-type optical waveguide 40-1, 40-2, or 40-3 by adjusting relative positions of the subcarrier 120 and the substrate 10 during manufacturing.

The size of the optical coupling function layer 20 is, for example, 100 mm² or less. If the size of the optical coupling function layer 20 is 100 mm² or less, it is suitable for xR glasses such as AR glasses and VR glasses.

The optical coupling function layer 20 can be produced in a known method. For example, the optical coupling function layer 20 is manufactured using semiconductor processes such as epitaxial growth, photolithography, etching, vapor deposition, and metallization.

When the visible light source module according to the present invention is applied as xR glasses such as AR glasses and VR glasses, the widths of a first multimode-interference-type optical coupling portion and a second multimode-interference-type optical coupling portion constituting the optical coupler are, for example, about 1 to 1000 μm, and the lengths thereof are, for example, preferably about 10 to 10000 μm.

For example, in a retina projection display, in order to display an image with a desired color, it is necessary to independently modulate the intensity of each of the three RGB colors representing visible light at high speed. When only visible laser light sources (electric current modulation) are performed in these modulations, the load on the IC that controls these modulations increases, but modulation (voltage modulation) of the Mach-Zehnder-type optical waveguide 40 (the optical coupling member 400 with the optical modulation function) can also be used. In this case, rough adjustment may be performed with an electric current (a visible laser light source) and fine adjustment may be performed with a voltage (the Mach-Zehnder-type optical waveguide 40) or rough adjustment may be performed with a voltage (the Mach-Zehnder-type optical waveguide 40) and fine adjustment may be performed with an electric current (a visible laser light source). It is preferable to employ the former if responsiveness is important because a process of performing fine adjustment using a voltage has better responsiveness and it is preferable to employ the latter if the suppression of power consumption is important because a process of performing fine adjustment using an electric current requires a small electric current.

### [Optical Engine]

In the present specification, the optical engine is a device including a plurality of light sources, an optical system including a coupling portion configured to couple a plurality of light beams output from the plurality of light sources into one light beam, an optical scanning mirror configured to reflect the light output from the optical system by changing an angle to display an image, and a control element configured to control an optical scanning mirror.

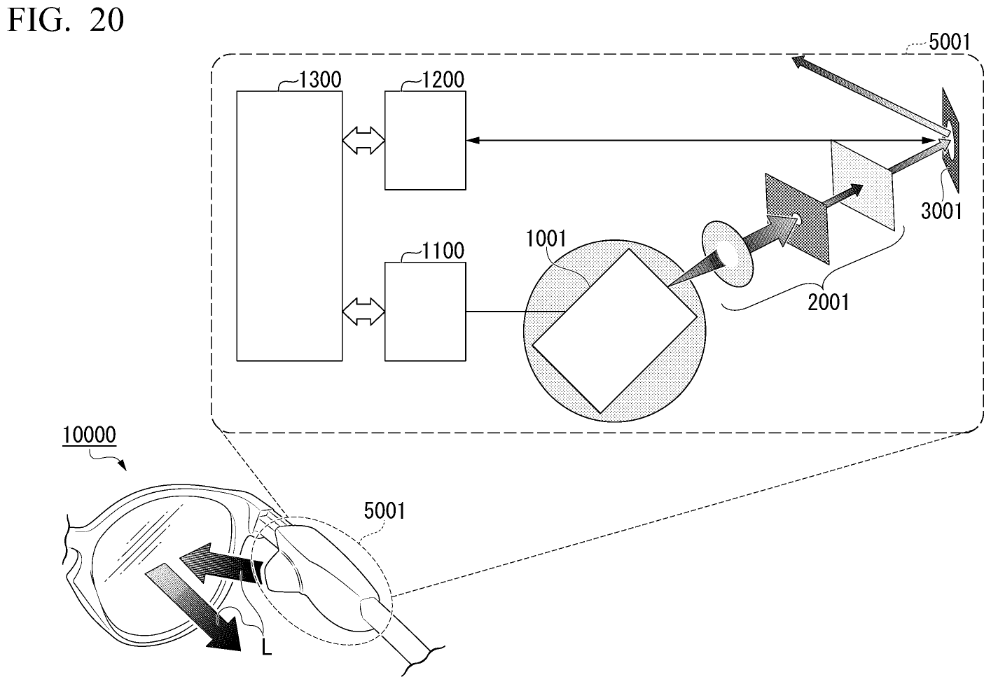

FIG. 20 shows a conceptual diagram for describing an optical engine 5001 according to the present embodiment. As shown in FIG. 20, a state in which the optical engine 5001 is mounted on a frame 10010 of glasses 10000 is shown. Reference sign L denotes image display light.

The optical engine 5001 includes a visible light source module 1001 and an optical scanning mirror 3001. As the visible light source module 1001 provided in the optical engine 5001, a visible light source module according to the above-described embodiment is used.

The laser light output from the visible light source module 1001 attached to the glasses frame is reflected by the optical scanning mirror, scanned, and input to the human eye, and an image (image) is projected directly onto the retina.

The optical scanning mirror 3001 is, for example, a MEMS mirror. In order to project the 2D image, it is preferable to have a two-axis MEMS mirror that vibrates so that the angle in the horizontal direction (the X-direction) and the vertical direction (the Y-direction) is changed to reflect laser light.

The optical engine 5001 includes a collimator lens 2001a, a slit 2001b, and an ND filter 2001c as an optical system for optically processing laser light output from the visible light source module 1001. This optical system is an example and may have other configurations.

The optical engine 5001 includes a laser driver 1100, an optical scanning mirror driver 1200, and a video controller 1300 that controls these drivers.

### EXAMPLES

Hereinafter, the present invention will be described in more detail with reference to examples. However, the present invention is not limited to the examples shown below.

The tables shown in Table 1 to Table 4 show results of investigating the propagation loss (dB) of each mode of visible light of RGB in the configuration shown in FIGS. 1 to 11 in the optimal dimensions of Example 3 shown in FIGS. 15A to 15C in simulation. The simulation software was Fimmwave (Photon Design).

The optimal dimensions in Example 3 are as follows.
The bending waveguide for the red light is as follows;
   Line width W_{R} of waveguide: 0.5 μm,
   Thickness T of waveguide: 0.7 μm,
   Thickness T_{slab} of slab portion: 0.15 μm,
   Radius r_{R} of circumferential shape portion: 20 μm, and
   Wavelength: 638 nm.
The bending waveguide for the green light is as follows;
   Line width W_{G} of waveguide: 0.5 μm,
   Thickness T of waveguide: 0.7 μm,
   Thickness T_{slab} of slab portion: 0.15 μm,
   Radius r_{G} of circumferential shape portion: 40 μm, and
   Wavelength: 520 nm.
The bending waveguide for the blue light is as follows;
   Line width W_{B} of waveguide: 0.9 μm,
   Thickness T of waveguide: 0.7 μm,
   Thickness T_{slab} of slab portion: 0.15 μm,
   Radius r_{B} of circumferential shape portion: 200 μm, and
   Wavelength: 455 nm.

There are the following corresponding relationships between the configurations of Examples 4-1 to 4-8 in Table 1 and the configurations shown in FIGS. 1, 2A to 2D, and 3A to 3C (first arrangement pattern (optical coupler of two-stage configuration));
Example 4-1: FIG. 3A
Example 4-2: FIG. 3B
Example 4-3: FIG. 3C
Example 4-4: FIG. 1
Example 4-5: FIG. 2A
Example 4-6: FIG. 2B
Example 4-7: FIG. 2C
Example 4-8: FIG. 2D

TABLE 1

| | Number of high-order | | | | | | | | | | | |
|---|---|---|---|---|---|---|---|---|---|---|---|---|
| | mode removal portions | | | Loss (Red) | | | Loss (Green) | | | Loss (Blue) | | |
| Example 4 | Red | Green | Blue | TM0 | TM1 | TM2 | TM0 | TM1 | TM2 | TM0 | TM1 | TM2 |
| Example 4-1 | 1 | 1 | 1 | 0 | 94 | 77 | 0 | 144 | 23 | 0 | 5 | 28 |
| Example 4-2 | 1 | 1 | 1 | 0 | 94 | 77 | 0 | 144 | 23 | 0 | 5 | 28 |
| Example 4-3 | 1 | 2 | 1 | 0 | 94 | 77 | 0 | 288 | 46 | 0 | 5 | 28 |
| Example 4-4 | 1 | 1 | 1 | 0 | 94 | 77 | 0 | 144 | 23 | 0 | 5 | 28 |
| Example 4-5 | 1 | 1 | 1 | 0 | 94 | 77 | 0 | 144 | 23 | 0 | 5 | 28 |
| Example 4-6 | 1 | 2 | 1 | 0 | 94 | 77 | 0 | 288 | 46 | 0 | 5 | 28 |
| Example 4-7 | 1 | 1 | 2 | 0 | 94 | 77 | 0 | 144 | 23 | 0 | 10 | 56 |
| Example 4-8 | 1 | 2 | 2 | 0 | 94 | 77 | 0 | 288 | 46 | 0 | 10 | 56 |

There are the following corresponding relationships between the configurations of Examples 5-1 to 5-7 in Table 2 and the configurations shown in FIGS. 4, FIGS. 5A to 5C, and FIGS. 6A to 6C (second arrangement pattern (optical coupler of two-stage configuration));
Example 5-1: FIG. 6A
Example 5-2: FIG. 6B
Example 5-3: FIG. 4
Example 5-4: FIG. 6C
Example 5-5: FIG. 5A
Example 5-6: FIG. 5B
Example 5-7: FIG. 5C

TABLE 2

| | Number of high-order | | | | | | | | | | | |
|---|---|---|---|---|---|---|---|---|---|---|---|---|
| | mode removal portions | | | Loss (Red) | | | Loss (Green) | | | Loss (Blue) | | |
| Example 5 | Red | Green | Blue | TM0 | TM1 | TM2 | TM0 | TM1 | TM2 | TM0 | TM1 | TM2 |
| Example 5-1 | 1 | 1 | 1 | 0 | 94 | 77 | 0 | 144 | 23 | 0 | 5 | 28 |
| Example 5-2 | 1 | 1 | 1 | 0 | 94 | 77 | 0 | 144 | 23 | 0 | 5 | 28 |
| Example 5-3 | 1 | 1 | 1 | 0 | 94 | 77 | 0 | 144 | 23 | 0 | 5 | 28 |
| Example 5-4 | 1 | 1 | 2 | 0 | 94 | 77 | 0 | 144 | 23 | 0 | 10 | 56 |
| Example 5-5 | 1 | 1 | 2 | 0 | 94 | 77 | 0 | 144 | 23 | 0 | 10 | 56 |
| Example 5-6 | 1 | 1 | 2 | 0 | 94 | 77 | 0 | 144 | 23 | 0 | 10 | 56 |
| Example 5-7 | 1 | 1 | 3 | 0 | 94 | 77 | 0 | 144 | 23 | 0 | 15 | 84 |

There are the following corresponding relationships between the configurations of Examples 6-1 to 6-7 in Table 3 and the configurations shown in FIGS. 7, 8A to 8C, and 9A to 9C (third arrangement pattern (optical coupler of two-stage configuration));
Example 6-1: FIG. 9A
Example 6-2: FIG. 9B
Example 6-3: FIG. 7
Example 6-4: FIG. 9C
Example 6-5: FIG. 8A
Example 6-6: FIG. 8B
Example 6-7: FIG. 8C

TABLE 3

| | Number of high-order | | | | | | | | | | | |
|---|---|---|---|---|---|---|---|---|---|---|---|---|
| | mode removal portions | | | Loss (Red) | | | Loss (Green) | | | Loss (Blue) | | |
| Example 6 | Red | Green | Blue | TM0 | TM1 | TM2 | TM0 | TM1 | TM2 | TM0 | TM1 | TM2 |
| Example 6-1 | 1 | 1 | 1 | 0 | 94 | 77 | 0 | 144 | 23 | 0 | 5 | 28 |
| Example 6-2 | 1 | 1 | 1 | 0 | 94 | 77 | 0 | 144 | 23 | 0 | 5 | 28 |
| Example 6-3 | 1 | 1 | 1 | 0 | 94 | 77 | 0 | 144 | 23 | 0 | 5 | 28 |
| Example 6-4 | 1 | 1 | 2 | 0 | 94 | 77 | 0 | 144 | 23 | 0 | 10 | 56 |
| Example 6-5 | 1 | 1 | 2 | 0 | 94 | 77 | 0 | 144 | 23 | 0 | 10 | 56 |
| Example 6-6 | 1 | 1 | 2 | 0 | 94 | 77 | 0 | 144 | 23 | 0 | 10 | 56 |
| Example 6-7 | 1 | 1 | 3 | 0 | 94 | 77 | 0 | 144 | 23 | 0 | 15 | 84 |

There are the following corresponding relationships between the configurations of Examples 7-1 to 7-3 in Table 4 and the configurations (optical coupler of one-stage configuration) shown in FIGS. 10, 11A, and 11B:
Example 7-1: FIG. 11B
Example 7-2: FIG. 10
Example 7-3: FIG. 11A

TABLE 4

| | Number of high-order | | | | | | | | | | | |
|---|---|---|---|---|---|---|---|---|---|---|---|---|
| | mode removal portions | | | Loss (Red) | | | Loss (Green) | | | Loss (Blue) | | |
| Example 7 | Red | Green | Blue | TM0 | TM1 | TM2 | TM0 | TM1 | TM2 | TM0 | TM1 | TM2 |
| Example 7-1 | 1 | 1 | 1 | 0 | 94 | 77 | 0 | 144 | 23 | 0 | 5 | 28 |
| Example 7-2 | 1 | 1 | 1 | 0 | 94 | 77 | 0 | 144 | 23 | 0 | 5 | 28 |
| Example 7-3 | 1 | 1 | 2 | 0 | 94 | 77 | 0 | 144 | 23 | 0 | 10 | 56 |

In any of Examples 4 to 7, the TM0 mode had zero loss. Also, it was found that TM1 mode and TM2 mode could be effectively removed.

Based on the results of the examples, the following findings were obtained for the removal of the high-order mode.

Regarding Example 4 (first arrangement pattern (optical coupler of two-stage configuration)), there was no difference in the removal of the high-order mode of the red light in Examples 4-1 to 4-8. On the other hand, regarding the removal of the high-order mode of the green light, Example 4-3, Example 4-6, and Example 4-8 among Examples 4-1 to 4-8 had the best removal effect. Regarding the removal of the high-order mode of the blue light, Examples 4-7 and 4-8 among Examples 4-1 to 4-8 had the best removal effect.

Regarding Example 5 (second arrangement pattern (optical coupler of two-stage configuration)), there was no difference in the removal of the high-order mode of the red light and the high-order mode of the green light in Examples 5-1 to 5-7. On the other hand, regarding the removal of the high-order mode of the blue light, Example 5-7 among Examples 5-1 to 5-7 had the best removal effect and Examples 5-4 to 5-6 had the second-best removal effect.

Regarding Example 6 (third arrangement pattern (optical coupler of two-stage configuration)), there was no difference in the removal of the high-order mode of the red light and the high-order mode of the green light in Examples 6-1 to 6-7. On the other hand, regarding the removal of the high-order mode of the blue light, Example 6-7 among Examples 6-1 to 6-7 had the best removal effect and Examples 6-4 to 6-6 had the second-best removal effect.

Regarding Example 7 (optical coupler of one-stage configuration), there was no difference in the removal of the high-order mode of the red light and the high-order mode of the green light in Examples 7-1 to 7-3. On the other hand, regarding the removal of the high-order mode of blue light, Example 7-3 among Examples 7-1 to 7-3 had the best removal effect.

While preferred embodiments of the invention have been described and illustrated above, it should be understood that these are exemplary of the invention and are not to be considered as limiting. Additions, omissions, substitutions, and other modifications can be made without departing from the features or scope of the present invention. Accordingly, the invention is not to be considered as being limited by the foregoing description, and is only limited by the scope of the appended claims.

### EXPLANATION OF REFERENCES

10 Substrate
20 Optical coupling function layer
25 High-order mode removal portion
30 Visible laser light source
40 Mach-Zehnder-type optical waveguide
50, 51 Optical coupling portion
100, 101, 102, 200, 210 Optical coupler
300 Optical coupling member
400 Optical coupler with optical modulation function
1000, 2000 Visible light source module
5001 Optical engine

What is claimed is:

1. An optical coupler for coupling a plurality of visible light beams having different wavelengths, the optical coupler comprising:
a plurality of light input ports to which the plurality of visible light beams can be input;
a light output port capable of coupling all of the plurality of visible light beams and outputting coupled light;
a one- or more-stage optical coupling portion to which a light-input-side optical waveguide and a light-output-side optical waveguide are connected; and
at least one high-order mode removal portion for visible light provided to remove a high mode with respect to each of the plurality of visible light beams,
wherein the optical coupling portion and each high-order mode removal portion for visible light are arranged so that each of the plurality of visible light beams passes through only a high-order mode removal portion for visible light or passes through only the high-order mode removal portion for the visible light and a high-order mode removal portion for visible light having a shorter wavelength than the visible light.

2. The optical coupler according to claim 1,
wherein the plurality of visible light beams having the different wavelengths are blue light whose peak wavelength is 380 nm to 500 nm, green light whose peak wavelength is 500 nm to 600 nm, and red light whose peak wavelength is 600 nm to 830 nm,
wherein the blue light passes through only a high-order mode removal portion for the blue light,
wherein the green light passes through only a high-order mode removal portion for the green light or passes through the high-order mode removal portion for the green light and the high-order mode removal portion for the blue light, and
wherein the red light passes through only a high-order mode removal portion for the red light, passes through only the high-order mode removal portion for the red light and the high-order mode removal portion for the green light, or passes through the high-order mode removal portion for the red light, the high-order mode removal portion for the green light, and the high-order mode removal portion for the blue light.

3. The optical coupler according to claim 2,
wherein the optical coupling portion includes a first multimode-interference-type optical coupling portion having two inputs and one output and a second multimode-interference-type optical coupling portion having two inputs and one output, and
wherein an optical waveguide for the red light and an optical waveguide for the green light are connected to a light input side of the first multimode-interference-type optical coupling portion, an optical waveguide connected to a light output side of the first multimode-interference-type optical coupling portion and an optical waveguide for the blue light are connected to a light input side of the second multimode-interference-type optical coupling portion, and an optical waveguide connected to a light output side of the second multimode-interference-type optical coupling portion is connected to the light output port.

4. The optical coupler according to claim 3, wherein the high-order mode removal portion for the blue light is arranged in an optical waveguide for connecting the light output side of the second multimode-interference-type optical coupling portion and the light output port.

5. The optical coupler according to claim 3, wherein the high-order mode removal portion for the blue light is arranged in an optical waveguide for connecting the light input side of the second multimode-interference-type optical coupling portion and the light input port for the blue light.

6. The optical coupler according to claim 2,
wherein the optical coupling portion includes a first multimode-interference-type optical coupling portion having two inputs and one output and a second multimode-interference-type optical coupling portion having two inputs and one output, and
wherein an optical waveguide for the red light and an optical waveguide for the blue light are connected to a light input side of the first multimode-interference-type optical coupling portion, an optical waveguide connected to a light output side of the first multimode-interference-type optical coupling portion and an optical waveguide for the green light are connected to a light input side of the second multimode-interference-type optical coupling portion, and an optical waveguide connected to a light output side of the second multimode-interference-type optical coupling portion is connected to the light output port.

7. The optical coupler according to claim 6, wherein the high-order mode removal portion for the blue light is arranged in an optical waveguide for connecting the light output side of the second multimode-interference-type optical coupling portion and the light output port.

8. The optical coupler according to claim 6, wherein the high-order mode removal portion for the blue light is arranged in an optical waveguide for connecting the light output side of the first multimode-interference-type optical coupling portion and the light input side of the second multimode-interference-type optical coupling portion.

9. The optical coupler according to claim 6, wherein the high-order mode removal portion for the blue light is arranged in an optical waveguide for connecting the light input side of the first multimode-interference-type optical coupling portion and the light input port for the blue light.

10. The optical coupler according to claim 2,
wherein the optical coupling portion includes a first multimode-interference-type optical coupling portion having two inputs and one output and a second multimode-interference-type optical coupling portion having two inputs and one output, and
wherein an optical waveguide for the green light and an optical waveguide for the blue light are connected to a light input side of the first multimode-interference-type optical coupling portion, an optical waveguide connected to a light output side of the first multimode-interference-type optical coupling portion and an optical waveguide for the red light are connected to a light input side of the second multimode-interference-type optical coupling portion, and an optical waveguide connected to a light output side of the second multimode-interference-type optical coupling portion is connected to the light output port.

11. The optical coupler according to claim 10, wherein the high-order mode removal portion for the blue light is arranged in an optical waveguide for connecting the light output side of the second multimode-interference-type optical coupling portion and the light output port.

12. The optical coupler according to claim 10, wherein the high-order mode removal portion for the blue light is arranged in an optical waveguide for connecting the light output side of the first multimode-interference-type optical coupling portion and the light input side of the second multimode-interference-type optical coupling portion.

13. The optical coupler according to claim 10, wherein the high-order mode removal portion for the blue light is arranged in an optical waveguide for connecting the light input side of the first multimode-interference-type optical coupling portion and the light input port for the blue light.

14. The optical coupler according to claim 2,
wherein the optical coupling portion includes a multimode-interference-type optical coupling portion having three inputs and one output, and
wherein an optical waveguide for the red light, an optical waveguide for the green light, and an optical waveguide for the blue light are connected to a light input side of the multimode-interference-type optical coupling portion having three inputs and one output and an optical waveguide connected to a light output side of the multimode-interference-type optical coupling portion having three inputs and one output is connected to the light output port.

15. The optical coupler according to claim 14, wherein the high-order mode removal portion for the blue light is arranged in an optical waveguide for connecting a light output side of the multimode-interference-type optical coupling portion having three inputs and one output and the light output port.

16. The optical coupler according to claim 1, wherein the high-order mode removal portion includes a bending waveguide.

17. The optical coupler according to claim 16, wherein a line width of the bending waveguide is 2.0 μm or less.

18. The optical coupler according to claim 16, wherein a line width of the bending waveguide is 0.2 μm or more.

19. The optical coupler according to claim 1, wherein the optical coupler includes a one- or more-stage multimode-interference-type optical coupling portion.

20. An optical coupling member comprising:
a substrate made of a material different from lithium niobate; and
an optical coupling function layer including a lithium niobate film formed on a main surface of the substrate,
wherein the optical coupler according to claim 1 is formed in the optical coupling function layer.

21. A visible light source module comprising:
the optical coupling member according to claim 20; and
a plurality of visible laser light sources configured to output visible light coupled by the optical coupling member.

22. An optical coupling member having an optical modulation function, comprising:
the optical coupling member according to claim 20; and
a Mach-Zehnder-type optical modulator connected to the optical coupling member and configured to guide a plurality of visible light beams output from a plurality of visible laser light sources to the optical coupling member.

23. A visible light source module comprising:
the optical coupling member having the optical modulation function according to claim 22; and
a plurality of visible laser light sources configured to output visible light coupled by the optical coupling member having the optical modulation function.

24. An optical engine comprising:
the visible light source module according to claim 21; and
an optical scanning mirror configured to reflect light output from the visible light source module by changing an angle so that an image is displayed.

25. An optical engine comprising:
the visible light source module according to claim 23; and
an optical scanning mirror configured to reflect light output from the visible light source module by changing an angle so that an image is displayed.
